(19) United States
(12) Patent Application Publication
(10) Pub. No.: US 2009/0244053 A1
(43) Pub. Date: Oct. 1, 2009

(54) Method for driving plasma display panel and plasma display apparatus

(76) Inventors: Keiji Akamatsu, Osaka (JP); Toshikazu Wakabayashi, Osaka (JP); Yasuhiro Arai, Osaka (JP); Mitsuhiro Murata, Kyoto (JP)

Correspondence Address: MCDERMOTT WILL & EMERY LLP, 600 13TH STREET, NW, WASHINGTON, DC, 20005-3096, US

(21) Appl. No.: 12/308,055

(22) PCT Filed: Jun. 6, 2007
(86) PCT No.: PCT/JP2007/061419

§ 371 Date: Dec. 5, 2008

(30) Foreign Application Priority Data
Jun. 7, 2006 (JP) 2006-158113
Jun. 7, 2006 (JP) 2006-158114

(51) Int. Cl. G06F 3/038; G09G 3/28

(52) U.S. Cl. 345/213; 345/60

(57) ABSTRACT

An object of the present invention is to provide a method for driving a plasma display panel capable of further reducing an address error to realize satisfactory image quality, and a plasma display apparatus.

The method for driving the plasma display panel according to the present invention includes the steps of: grouping a plurality of scan electrodes into two scan electrode groups on odd-numbered rows and on even-numbered rows; dividing an address period of each of sub-field periods into first and second sub-periods (Ta, Tb) to which the scan electrode groups are assigned, respectively; sequentially selecting the scan electrode by applying a selective potential (Vb) or a first non-selective potential (Vs) to the scan electrode of each scan electrode group in each sub-period (Ta, Tb); applying an address potential (Vw) to a data electrode (D1 to Dm) to be selected in sync with the selection of the scan electrode; setting a time (Ta) during which the selective potential (Vb) is applied in the first sub-period (Ta) to be shorter than a time (Tb) during which the selective potential (Vb) is applied in the second sub-period (Tb); and applying in the first sub-period (Ta) a second non-selective potential (Vx) higher than the first non-selective potential (Vs) to the scan electrode group assigned to the second sub-period (Tb).

### TECHNICAL FIELD

The present invention relates to a method for driving an alternating-current plasma display panel, and a plasma display apparatus.

### BACKGROUND ART

In an alternating current surface discharge panel as a typical plasma display panel (hereinafter referred to as “PDP”), a large number of discharge cells are formed between a front plate and a back plate of two substrates opposed to each other. In the front plate, plural pairs of display electrodes are formed on a front glass substrate, and a dielectric layer and a protective layer (MgO thin film for example) are formed to cover the display electrodes. Note that each pair of display electrodes are constituted by a scan electrode and a sustain electrode which form a pair and are disposed in parallel with each other. In the back plate, a plurality of data electrodes are formed on a back glass substrate to be in parallel with each other, a dielectric layer is formed to cover the data electrodes, a plurality of partition walls are formed on the dielectric layer to be in parallel with the data electrodes, and a phosphor layer is formed on a surface of the dielectric layer and side surfaces of the partition walls. The front plate and the back plate are disposed to be opposed to each other such that the display electrodes and the data electrodes are three-dimensionally intersect with each other. With this, the front plate and the back plate are sealed, and discharge spaces inside such assembly of the front plate and the back plate are filled with a discharge gas. Each discharge cell includes a pair of display electrodes, one data electrode, and the discharge space therebetween.

A plasma display apparatus including the above-described PDP includes driving circuits which supply driving potential signals to respective electrodes of the PDP, specifically, a scan electrode driving circuit which supplies the driving potential signal to the scan electrodes, a sustain electrode driving circuit which supplies the driving potential signal to the sustain electrodes, and a data electrode driving circuit which supplies the driving potential signal to the data electrodes.

The plasma display apparatus normally displays about 50 to 100 images per second, and each image is called a field. In a common method for driving the PDP, the field is divided into a plurality of sub-fields, and a gray scale display is carried out by combinations of the sub-fields in which light is emitted (sub-field method).

FIG. 9 is a waveform diagram of the driving potential signals supplied to respective electrodes in a conventional method for driving the PDP using the sub-field method. In the PDP used herein, as shown in FIG. 2 for example, n scan electrodes SCN1 to SCNn and n sustain electrodes SUS1 to SUSn are alternately arranged in a row direction, and m data electrodes D1 to Dm are arranged in a column direction.

One field period includes first to x-th sub-fields, i.e., x sub-fields each including a reset period, an address period, and a sustain period, and these sub-fields are abbreviated as a first SF, a second SF, . . . , and an x-th SF. Carried out in the reset period is any one of an all-cell reset operation by which reset discharge of all the discharge cells carrying out image display is carried out, and a selective reset operation by which the reset discharge of only the discharge cells which have lit in the sustain period of an immediately preceding sub-field is selectively carried out. For example, whether to carry out the all-cell reset operation or the selective reset operation in the reset period of each sub-field is determined based on an average brightness level (APL) of the image data to be displayed (see Patent Document 1 for example).

First, an operation in the sub-field in which the all-cell reset operation is carried out in the reset period will be explained.

For example, the all-cell reset operation is carried out in the reset period of the first SF. In a former period of the reset period of the first SF, application of a gradually rising lamp potential to the scan electrodes SCN1 to SCNn causes weak reset discharge in which the scan electrodes SCN1 to SCNn are anodes and the sustain electrodes SUS1 to SUSn and the data electrodes D1 to Dm are cathodes. With this, wall electric charge necessary for an address operation is generated on each electrode. At this time, the wall electric charge is excessively generated since the wall electric charge will be optimized later. In a latter period of the reset period of the first SF, application of a gradually dropping lamp potential to the scan electrodes SCN1 to SCNn causes second weak reset discharge in which the scan electrodes SCN1 to SCNn are the cathodes and the sustain electrodes SUS1 to SUSn and the data electrodes D1 to Dm are the anodes. With this, the wall electric charge excessively accumulated on each electrode is reduced, thereby adjusting the wall electric charge to an appropriate amount for each discharge cell.

Next, in the address period of the first SF, the address discharge is caused in the discharge cell which is caused to light in the sustain period after this address period. First, the address operation is carried out in the address period. To be specific, by applying a scan pulse potential Vb (V) to the scan electrode SCN1 on the first row and a positive address pulse potential Vw (V) to the data electrode Dk, among the data electrodes D1 to Dm, of the discharge cell which is caused to light on the first row, the address discharge is caused in the discharge cell which is caused to light in the first row, and the wall electric charge is therefore accumulated on each electrode. This address operation is sequentially carried out up to the discharge cells on an n-th row. Then, the address period terminates. As above, in the address period, by sequentially applying the scan pulse to the scan electrodes and applying to the data electrodes the address pulse potential corresponding to an image signal to be displayed, the address discharge is selectively caused between the scan electrode and the data electrode, thereby selectively generating the wall electric charge.

Next, in the sustain period of the first SF, by alternately applying a sustain pulse potential Vm (V) to the scan electrodes SCN1 to SCNn and the sustain electrodes SUS1 to SUSn, the sustain discharge is caused in the discharge cell in which the address discharge has occurred. With this, the corresponding phosphor layer of the discharge cell is caused to emit light, thereby carrying out image display.

Next, an operation in the sub-field in which the selective reset operation is carried out in the reset period will be explained.

For example, the selective reset operation is carried out in the reset period of the second SF. In this reset period, the sustain electrodes SUS1 to SUSn are held at Vh (V), the data electrodes D1 to Dm are held at 0 (V), and a lamp potential gradually dropping from Vq (V) to Va (V) is applied to the scan electrodes SCN1 to SCNn. With this, the weak reset discharge is caused in the discharge cell in which the sustain discharge has been carried out in the sustain period of the immediately preceding sub-field. With this, the excessive wall electric charge on the scan electrode SCNi, the sustain electrode SUSi, and the data electrode Dk is reduced, thereby adjusting the wall electric charge to an amount suitable for the address operation. In contrast, discharge is not caused in the discharge cell in which the address discharge and the sustain discharge are not carried out in the immediately preceding sub-field.

The address period and the sustain period after this reset period of the second SF are the same as the address period and the sustain period of the sub-field (for example, the first SF) in which the all-cell reset operation is carried out in the reset period, so that explanations thereof are omitted.

Next, problems in driving the PDP by a series of above periods will be explained in reference to FIGS. 10, 11, and 12.

FIG. 10 shows the address period of one sub-field. FIG. 11(a) schematically shows a state of the wall electric charge in the cell at a time t1 of FIG. 10, and FIG. 11(b) schematically shows a state of the wall electric charge in the cell at a time t2 of FIG. 10. As shown in FIG. 11(a), the wall electric charge in the discharge cell at the time t1 of FIG. 10 is distributed such that, since the reset period is just terminated, negative wall electric charge is adequately accumulated on the scan electrodes SCN (SCN1 to SCNn), and positive wall electric charge is adequately accumulated on the sustain electrodes SUS (SUS1 to SUSn) and the data electrodes DATA (D1 to Dm). In contrast, as shown in FIG. 11(b), the wall electric charge on respective electrodes in the discharge cell at the time t2 of FIG. 10 is reduced as compared to FIG. 11(a). This is because priming particles floating in a discharge cell space by the reset discharge and the sustain discharge, electrons emitted from MgO of the protective layer activated by the sustain discharge, and the like are accelerated by an electric field in the discharge cell which is standing by for addressing, and the wall electric charge accumulated by the reset discharge is gradually neutralized.

When the address operation is carried out in a state shown in FIG. 11(a), discharge time lag becomes small and satisfactory address discharge is realized due to adequate wall electric charge and priming particles. In contrast, when the address operation is carried out in a state shown in FIG. 11(b), due to inadequate wall electric charge and priming particles, the discharge time lag becomes large, a large number of address errors occur, and satisfactory image quality cannot be obtained. Used as a method for suppressing such phenomenon is a method for increasing a scan pulse voltage Vscn to weaken the electric field in the discharge cell which is standing by for the addressing, thereby suppressing neutralization of the wall electric charge. FIG. 12 is a diagram showing one example of the scan pulse voltage Vscn necessary for carrying out satisfactory address discharge, with respect to an address standby time (The scan pulse voltage Vscn changes depending on the method for driving the PDP and the PDP). The address standby time is shown by (the number n of scan electrodes)×(the time during which the scan pulse is applied to one scan electrode)+(the total of the times between the scan pulses). An upper limit of the scan pulse voltage Vscn is determined depending on the withstand voltage of a driver circuit used as the scan electrode driving circuit, so that a drivable range is determined as shown in FIG. 12. In recent years, the address standby time is sharply increasing due to the increase in resolution, such as full-spec high definition and super high definition (2k4k), so that it is increasingly difficult to drive the PDP within this drivable range.

To solve these problems, disclosed as a method for driving the PDP is a method for reducing the above neutralization phenomenon of the electric charge by dividing the address period into a former period and a latter period and applying in the former period of the address period a predetermined potential for suppressing the neutralization of the wall electric charge to the scan electrode to be selected in the latter period of the address period (see Patent Documents 2 and 3 for example).

Patent Document 1: Japanese Laid-Open Patent Application Publication No. 2005-326611

Patent Document 2: Japanese Patent No. 3511495

Patent Document 3: Japanese Laid-Open Patent Application Publication No. 2005-316480

### DISCLOSURE OF THE INVENTION

### Problems to be Solved by the Invention

As above, the address error can be reduced to some extent by dividing the address period into the former period and the latter period and applying in the former period of the address period the predetermined potential for suppressing the neutralization of the wall electric charge to the scan electrode to be selected in the latter period of the address period. However, it is difficult to completely eliminate the address error even by this method, and there is room for improvement to further reduce the address error. Note that the address error is such a phenomenon that adequate address discharge is not caused or the address discharge is not caused at all in the discharge cell in which the address discharge should be carried out, so that the sustain discharge is not carried out (the discharge cell does not light) in the sustain period.

Moreover, for example, in a case where the scan electrodes arranged from an upper end to lower end of the PDP are selected in this arrangement order to carry out the address operation and are grouped into an electrode group including the scan electrodes which are selected in the former period of the address period and located in the upper half of the PDP and an electrode group including the scan electrodes which is selected in the latter period of the address period and located in the lower half of the PDP, and the electrode groups are driven, a brightness difference is generated on an image surface in the vicinity of a boundary between the electrode groups due to the difference of a circuit impedance between the electrode groups, the difference of load between the electrode groups, and the like. For example, in a case where the image in the vicinity of the boundary between the electrode groups is a low gray scale display image, the brightness difference generated on the image surface in the vicinity of the boundary between the electrode groups appears as bright lines and dark lines, thereby significantly deteriorating the image quality.

The present invention was made to solve the above problems, and an object of the present invention is to provide a method for driving a plasma display panel capable of further reducing the address error to realize satisfactory image quality, and a plasma display apparatus.

### Means for Solving the Problems

To achieve the above object, a method for driving a plasma display panel according to the present invention is a method for driving a plasma display panel in which plural pairs of display electrodes, each pair being formed by a scan electrode and a sustain electrode forming a pair, and a plurality of data electrodes are arranged to intersect with each other with a gap therebetween, and which includes a plurality of discharge cells each of which includes the pair of display electrodes and the data electrode forming the gap and has a discharge space in the gap, the method including the steps of: grouping a plurality of the scan electrodes included in the plural pairs of display electrodes into a plurality of scan electrode groups such that: said plurality of scan electrodes are grouped into said plurality of scan electrode groups; each of the scan electrode groups includes a plurality of scan electrode sub-groups each including at least one scan electrode; the scan electrode sub-groups included in the different scan electrode groups are adjacent to each other; and the scan electrode sub-groups included in the same scan electrode group are not adjacent to each other; dividing each field period into a plurality of sub-fields each including a reset period in which an inside of the discharge cell is caused to be an electrically charged state in which address discharge is able to be carried out, an address period in which the address discharge is caused in the discharge cell which is caused to light, and a sustain period in which the discharge cell in which the address discharge is caused is caused to light; dividing the address period in each of the sub-fields into a plurality of address sub-periods to which the different scan electrode groups are assigned, respectively; sequentially selecting the scan electrode by applying a selective potential or a first non-selective potential based on selection or non-selection to the scan electrode of the scan electrode group assigned to the address sub-period, and applying an address potential to the data electrode to be selected in sync with the selection of the scan electrode so that the address discharge is caused in the address sub-period in the discharge cell to be lit among the discharge cells including the scan electrodes of the scan electrode group assigned to the address sub-period; setting a time during which the selective potential is applied to the scan electrode in one of said plurality of address sub-periods other than a last one of the address sub-periods to be shorter than a time during which the selective potential is applied to the scan electrode in the last one of the address sub-periods; and applying a second non-selective potential higher than the first non-selective potential to the scan electrodes of one of the scan electrode groups in any one of the address sub-periods before the address sub-period to which said one of the scan electrode groups is assigned.

In accordance with this method, the address period after the reset period is divided into a plurality of address sub-periods, and the second non-selective potential higher than the first non-selective potential is applied to the scan electrodes of a certain scan electrode group (referred to as a scan electrode group α) in any one of the address sub-periods before the address sub-period to which the scan electrode group α is assigned. With this, it is possible to solve the conventional problem, i.e., suppress the neutralization of the wall electric charge in the discharge cell corresponding to the scan electrode group α. Further, the time during which the selective potential is applied to the scan electrode in a certain address sub-period (referred to as an address sub-period Tx) is set to be shorter than the time during which the selective potential is applied to the scan electrode in the last address sub-period. With this, the address sub-period Tx can be shortened, so that the address sub-period after the address sub-period Tx can be moved closer to the time of the termination of the reset period. Thus, it is possible to suppress the reduction in the wall electric charge and the priming particles during the address standby of the discharge cell which may be subjected to the address discharge in the address sub-period after the address sub-period Tx. With this, an electrically charged state in which the address discharge can be carried out at the time of the termination of the reset period can be maintained more satisfactorily, and it is possible to further reduce the address error caused due to the increase in the address standby time. Moreover, each scan electrode group includes a plurality of scan electrode sub-groups each including at least one scan electrode, and the scan electrode groups are grouped such that the scan electrode sub-groups included in different scan electrode groups are adjacent to each other, and the scan electrode sub-groups of the same scan electrode group are not adjacent to each other. Therefore, the scan electrodes belonging to respective scan electrode groups exist substantially uniformly on the entire panel surface (image surface) of the PDP. On this account, the brightness difference generated on the image surface by, for example, the difference of the circuit impedance between the scan electrode groups and the difference of load between the scan electrode groups becomes unnoticeable, and the generation of bright lines and dark lines can be prevented. Thus, satisfactory image quality can be obtained.

Moreover, the method may further include the steps of: applying a first standby potential to the sustain electrodes which form pairs with the scan electrodes of the scan electrode group assigned to the address sub-period; and applying a second standby potential lower than the first standby potential to the sustain electrodes which form pairs with the scan electrodes of said one scan electrode group in any one of the address sub-periods before the address sub-period to which said one scan electrode group is assigned.

In accordance with this method, the second non-selective potential higher than the first non-selective potential is applied to the scan electrodes of a certain scan electrode group (referred to as a scan electrode group α) in any one of the address sub-periods before the address sub-period to which the scan electrode group α is assigned, and further, the second standby potential lower than the first standby potential is applied to the sustain electrodes which form pairs with the scan electrodes of the scan electrode group α. With this, it is possible to further suppress the conventional problem, i.e., the neutralization of the wall electric charge in the discharge cell corresponding to the scan electrode group α.

Moreover, the second standby potential may be higher than the selective potential.

Moreover, the second standby potential may be a ground potential.

Moreover, the method may further includes the steps of: applying the second non-selective potential to the scan electrodes of said one scan electrode group in the address sub-period immediately before the address sub-period to which said one scan electrode group is assigned; providing between the address sub-period immediately before the address sub-period to which said one scan electrode group is assigned and the address sub-period to which said one scan electrode group is assigned, an address stop period which has a predetermined time and in which the selective potential is not applied to any scan electrodes; and switching the potential applied to the scan electrodes of said one scan electrode group from the second non-selective potential to the first non-selective potential in a former half period of the address stop period.

In accordance with this method, in a case where the second non-selective potential is applied to the scan electrode of a certain scan electrode group (referred to as a scan electrode group α) in the address sub-period immediately before the address sub-period (referred to as an address sub-period Ty) to which the scan electrode group α is assigned, the first non-selective potential is once applied to the scan electrode of the scan electrode group α in the address sub-period Ty. When switching from the second non-selective potential to the first non-selective potential, the potential of the sustain electrode which is capacitive-coupled to the scan electrode changes, and this changes the potential of the scan electrode. The address error is more likely to occur when carrying out the address discharge at this time. Therefore, the address stop period is provided, and the potential applied to the scan electrode of the scan electrode group α is switched from the second non-selective potential to the first non-selective potential in the former half period of the address stop period. With this, the address sub-period Ty can be started after the change in the potential of the sustain electrode terminates or substantially terminates. Thus, the above-described address error can be prevented.

Moreover, it is preferable that the predetermined time of the address stop period be preset such that a change in the potential of the sustain electrode caused by switching the potential applied to the scan electrodes of said one scan electrode group to the first non-selective potential in the former half period of the address stop period substantially terminates within the address stop period.

Moreover, any one of a first lamp potential which drops after rising and a second lamp potential which drops from a potential lower than a highest potential of the first lamp potential may be applied to the scan electrode in the reset period of each sub-field period, and the second non-selective potential may be lower than the highest potential of the first lamp potential.

Moreover, the number of the scan electrode groups may be two.

The increase in the number of the scan electrode groups causes complication of the circuit which drives the scan electrode and complication of control. In consideration of these demerits, it is preferable that the number of the scan electrode groups be two.

Moreover, the scan electrode group assigned to each of the address sub-periods may be different for each field.

In accordance with this method, even if the address error occurs due to the increase in the address standby time, the positions of the discharge cells which do not light due to this address error are different for each field, so that the deterioration in the image quality due to unlighting of the discharge cells cannot be recognized with eyes and becomes unnoticeable.

Moreover, the scan electrode group assigned to each of the address sub-periods may be different for each sub-field.

In accordance with this method, even if the address error occurs due to the increase in the address standby time, the positions of the discharge cells which do not light due to this address error are different for each sub-field, so that the deterioration in the image quality due to unlighting of the discharge cells cannot be recognized with eyes and becomes unnoticeable.

Moreover, the scan electrode group assigned to each of the address sub-periods may be different for each field and each sub-field.

In accordance with this method, even if the address error occurs due to the increase in the address standby time, the positions of the discharge cells which do not light due to this address error are different for each field and each sub-field, so that the deterioration in the image quality due to unlighting of the discharge cells cannot be recognized with eyes and becomes unnoticeable.

Moreover, the discharge cell may be filled with a discharge gas containing a xenon gas at a partial-pressure ratio of 7% or higher.

The address error due to the increase in the address standby time has often occurred when the partial-pressure ratio of the xenon gas in the discharge cell was high, i.e., 7% or higher. Therefore, in this case, the address error can be reduced more effectively.

Moreover, each of the data electrodes may be arranged to intersect with all the scan electrodes, and the scan electrodes may be selected one by one in the address period.

This method is a method using the single scan method. Since the address standby time of the single scan method is longer than that of the double scan method, the address error can be reduced more effectively.

Moreover, an area occupied by each of the discharge cells may be not less than 2.696×10⁻⁴ cm² and not more than 4.432×10⁻³ cm².

In a case where the resolution of the plasma display panel is high, such as one million pixels (HD) or more, the area of the discharge cell becomes small as above, and the address error due to the increase in the address standby time is more likely to occur. Therefore, in this case, the address error can be reduced more effectively.

Moreover, a plasma display apparatus according to the present invention includes: a plasma display panel in which plural pairs of display electrodes, each pair being formed by a scan electrode and a sustain electrode forming a pair, and a plurality of data electrodes are arranged to intersect with each other with a gap therebetween, and which includes a plurality of discharge cells each of which includes the pair of display electrodes and the data electrode forming the gap and has a discharge space in the gap; and a driving device which drives the plasma display panel, wherein the driving device is configured to: group a plurality of the scan electrodes included in the plural pairs of display electrodes into a plurality of scan electrode groups such that said plurality of scan electrodes are grouped into said plurality of scan electrode groups, each of the scan electrode groups includes a plurality of scan electrode sub-groups each including at least one scan electrode, the scan electrode sub-groups included in the different scan electrode groups are adjacent to each other, and the scan electrode sub-groups included in the same scan electrode group are not adjacent to each other; divide each field period into a plurality of sub-fields each including a reset period in which an inside of the discharge cell is caused to be an electrically charged state in which address discharge is able to be carried out, an address period in which the address discharge is caused in the discharge cell which is caused to light, and a sustain period in which the discharge cell in which the address discharge is caused is caused to light; divide the address period in each of the sub-fields into a plurality of address sub-periods to which the different scan electrode groups are assigned, respectively; sequentially select the scan electrode by applying a selective potential or a first non-selective potential based on selection or non-selection to the scan electrode of the scan electrode group assigned to the address sub-period, and applying an address potential to the data electrode to be selected in sync with the selection of the scan electrode so that the address discharge is caused in the address sub-period in the discharge cell to be lit among the discharge cells including the scan electrodes of the scan electrode group assigned to the address sub-period; set a time during which the selective potential is applied to the scan electrode in one of said plurality of address sub-periods other than a last one of the address sub-periods to be shorter than a time during which the selective potential is applied to the scan electrode in the last one of the address sub-periods; and apply a second non-selective potential higher than the first non-selective potential to the scan electrodes of one of the scan electrode groups in any one of the address sub-periods before the address sub-period to which said one of the scan electrode groups is assigned.

In accordance with this configuration, the address period after the reset period is divided into a plurality of address sub-periods, and the second non-selective potential higher than the first non-selective potential is applied to the scan electrodes of a certain scan electrode group (referred to as a scan electrode group α) in any one of the address sub-periods before the address sub-period to which the scan electrode group α is assigned. With this, it is possible to solve the conventional problem, i.e., suppress the neutralization of the wall electric charge in the discharge cell corresponding to the scan electrode group α. Further, the time during which the selective potential is applied to the scan electrode in a certain address sub-period (referred to as an address sub-period Tx) is set to be shorter than the time during which the selective potential is applied to the scan electrode in the last address sub-period. With this, the address sub-period Tx can be shortened, so that the address sub-period after the address sub-period Tx can be moved closer to the time of the termination of the reset period. Thus, it is possible to suppress the reduction in the wall electric charge and the priming particles during the address standby of the discharge cell which may be subjected to the address discharge in the address sub-period after the address sub-period Tx. With this, an electrically charged state in which the address discharge can be carried out at the time of the termination of the reset period can be maintained more satisfactorily, and it is possible to further reduce the address error caused due to the increase in the address standby time. Moreover, each scan electrode group includes a plurality of scan electrode sub-groups each including at least one scan electrode, and the scan electrode groups are grouped such that the scan electrode sub-groups included in different scan electrode groups are adjacent to each other, and the scan electrode sub-groups of the same scan electrode group are not adjacent to each other. Therefore, the scan electrodes belonging to respective scan electrode groups exist substantially uniformly on the entire panel surface (image surface) of the PDP. On this account, the brightness difference generated on the image surface by, for example, the difference of the circuit impedance between the scan electrode groups and the difference of load between the scan electrode groups becomes unnoticeable, and the generation of bright lines and dark lines can be prevented. Thus, satisfactory image quality can be obtained.

Moreover, the driving device may be configured to apply a first standby potential to the sustain electrodes which form pairs with the scan electrodes of the scan electrode group assigned to the address sub-period, and apply a second standby potential lower than the first standby potential to the sustain electrodes which form pairs with the scan electrodes of said one scan electrode group in any one of the address sub-periods before the address sub-period to which said one scan electrode group is assigned.

In accordance with this configuration, the second non-selective potential higher than the first non-selective potential is applied to the scan electrodes of a certain scan electrode group (referred to as a scan electrode group α) in any one of the address sub-periods before the address sub-period to which the scan electrode group α is assigned, and further, the second standby potential lower than the first standby potential is applied to the sustain electrodes which form pairs with the scan electrodes of the scan electrode group α. With this, it is possible to further suppress the conventional problem, i.e., the neutralization of the wall electric charge in the discharge cell corresponding to the scan electrode group α.

Moreover, the second standby potential may be higher than the selective potential.

Moreover, the second standby potential may be a ground potential.

Moreover, the driving device may be configured to apply the second non-selective potential to the scan electrodes of said one scan electrode group in the address sub-period immediately before the address sub-period to which said one scan electrode group is assigned, provide between the address sub-period immediately before the address sub-period to which said one scan electrode group is assigned and the address sub-period to which said one scan electrode group is assigned, an address stop period which has a predetermined time and in which the selective potential is not applied to any scan electrodes, and switch the potential applied to the scan electrodes of said one scan electrode group from the second non-selective potential to the first non-selective potential in a former half period of the address stop period.

In accordance with this configuration, in a case where the second non-selective potential is applied to the scan electrode of a certain scan electrode group (referred to as a scan electrode group α) in the address sub-period immediately before the address sub-period (referred to as an address sub-period Ty) to which the scan electrode group α is assigned, the first non-selective potential is once applied to the scan electrode of the scan electrode group α in the address sub-period Ty. When switching from the second non-selective potential to the first non-selective potential, the potential of the sustain electrode which is capacitive-coupled to the scan electrode changes, and this changes the potential of the scan electrode. The address error is more likely to occur when carrying out the address discharge at this time. Therefore, the address stop period is provided, and the potential applied to the scan electrode of the scan electrode group α is switched from the second non-selective potential to the first non-selective potential in the former half period of the address stop period. With this, the address sub-period Ty can be started after the change in the potential of the sustain electrode terminates or substantially terminates. Thus, the above-described address error can be prevented.

Moreover, it is preferable that the driving device preset the predetermined time of the address stop period such that a change in the potential of the sustain electrode caused by switching the potential applied to the scan electrodes of said one scan electrode group to the first non-selective potential in the former half period of the address stop period substantially terminates within the address stop period.

Moreover, the driving device may apply to the scan electrode in the reset period of each sub-field period, any one of a first lamp potential which drops after rising and a second lamp potential which drops from a potential lower than a highest potential of the first lamp potential, and the second non-selective potential may be lower than the highest potential of the first lamp potential.

Moreover, the number of the scan electrode groups may be two.

The increase in the number of the scan electrode groups causes complication of the circuit which drives the scan electrode and complication of control. In consideration of these demerits, it is preferable that the number of the scan electrode groups be two.

Moreover, the scan electrode group assigned to each of the address sub-periods may be different for each field.

In accordance with this configuration, even if the address error occurs due to the increase in the address standby time, the positions of the discharge cells which do not light due to this address error are different for each field, so that the deterioration in the image quality due to unlighting of the discharge cells cannot be recognized with eyes and becomes unnoticeable.

Moreover, the scan electrode group assigned to each of the address sub-periods may be different for each sub-field.

In accordance with this configuration, even if the address error occurs due to the increase in the address standby time, the positions of the discharge cells which do not light due to this address error are different for each sub-field, so that the deterioration in the image quality due to unlighting of the discharge cells cannot be recognized with eyes and becomes unnoticeable.

Moreover, the scan electrode group assigned to each of the address sub-periods may be different for each field and each sub-field.

In accordance with this configuration, even if the address error occurs due to the increase in the address standby time, the positions of the discharge cells which do not light due to this address error are different for each field and each sub-field, so that the deterioration in the image quality due to unlighting of the discharge cells cannot be recognized with eyes and becomes unnoticeable.

Moreover, the discharge cell may be filled with a discharge gas containing a xenon gas at a partial-pressure ratio of 7% or higher.

The address error due to the increase in the address standby time has often occurred when the partial-pressure ratio of the xenon gas in the discharge cell was high, i.e., 7% or higher. Therefore, in this case, the address error can be reduced more effectively.

Moreover, each of the data electrodes may be arranged to intersect with all the scan electrodes, and the driving device may select the scan electrodes one by one in the address period.

This configuration is a configuration using the single scan method. Since the address standby time of the single scan method is longer than that of the double scan method, the address error can be reduced more effectively.

Moreover, an area occupied by each of the discharge cells may be not less than 2.696×10⁻⁴ cm² and not more than 4.432×10⁻³ cm².

In a case where the resolution of the plasma display panel is high, such as one million pixels (HD) or more, the area of the discharge cell becomes small as above, and the address error due to the increase in the address standby time is more likely to occur. Therefore, in this case, the address error can be reduced more effectively.

### EFFECTS OF THE INVENTION

The present invention has the above-explained configurations, and has an effect of providing a method for driving a plasma display panel capable of further reducing the address error to realize satisfactory image quality, and a plasma display apparatus.

The above object, other objects, features and advantages of the present invention will be made clear by the following detailed explanation of preferred embodiments with reference to the attached drawings.

### BRIEF DESCRIPTION OF THE DRAWINGS

FIG. 1 is a perspective view showing main portions of a plasma display panel used in a plasma display apparatus according to Embodiment 1 of the present invention.

FIG. 2 is a diagram showing the arrangement of electrodes of the plasma display panel of FIG. 1.

FIG. 3 is a block diagram showing the configuration of the plasma display apparatus according to Embodiment 1 of the present invention.

FIG. 4 is a diagram showing a relation of connection among scan electrodes, sustain electrodes, and respective driving circuits in Embodiment 1 of the present invention.

FIG. 5 is a waveform diagram of driving potential signals applied to respective electrodes in a method for driving the plasma display panel in Embodiment 1 of the present invention.

FIG. 6 is a waveform diagram showing potentials of respective electrodes in an address period in Modification Example of Embodiment 1.

FIG. 7 is a diagram showing a relation of connection among the scan electrodes, the sustain electrodes, and respective driving circuits in Embodiment 2 of the present invention.

FIG. 8 is a waveform diagram of the driving potential signals applied to respective electrodes in the method for driving the plasma display panel in Embodiment 2 of the present invention.

FIG. 9 is a waveform diagram of the driving potential signals applied to respective electrodes in the method for driving a conventional plasma display panel.

FIG. 10 is a waveform diagram of the driving potential signals applied to the scan electrode and the sustain electrode, which is shown to explain problems of a method for driving the conventional plasma display panel.

FIG. 11(a) is a diagram schematically showing a state of the wall electric charge in a cell at a time t1 of FIG. 10, and FIG. 11(b) is a diagram schematically showing a state of the wall electric charge in a cell at a time t2 of FIG. 10.

FIG. 12 is a diagram showing one example of a scan pulse voltage necessary for carrying out satisfactory address discharge, with respect to an address standby time.

### EXPLANATION OF REFERENCE NUMBERS

D1 to Dm data electrode
SCN1 to SCNn scan electrode
SUS1 to SUNn sustain electrode
1 plasma display panel
4A scan electrode group on odd-numbered rows
4B scan electrode group on even-numbered rows
5A sustain electrode group on odd-numbered rows
5B sustain electrode group on even-numbered rows
12 data electrode driving circuit
13 scan electrode driving circuit
14 sustain electrode driving circuit
15 timing generator circuit
16 A/D converter
17 scan number converter
18 sub-field converter
19 APL detector

### BEST MODE FOR CARRYING OUT THE INVENTION

Hereinafter, preferred embodiments of the present invention will be explained in reference to the drawings.

### Embodiment 1

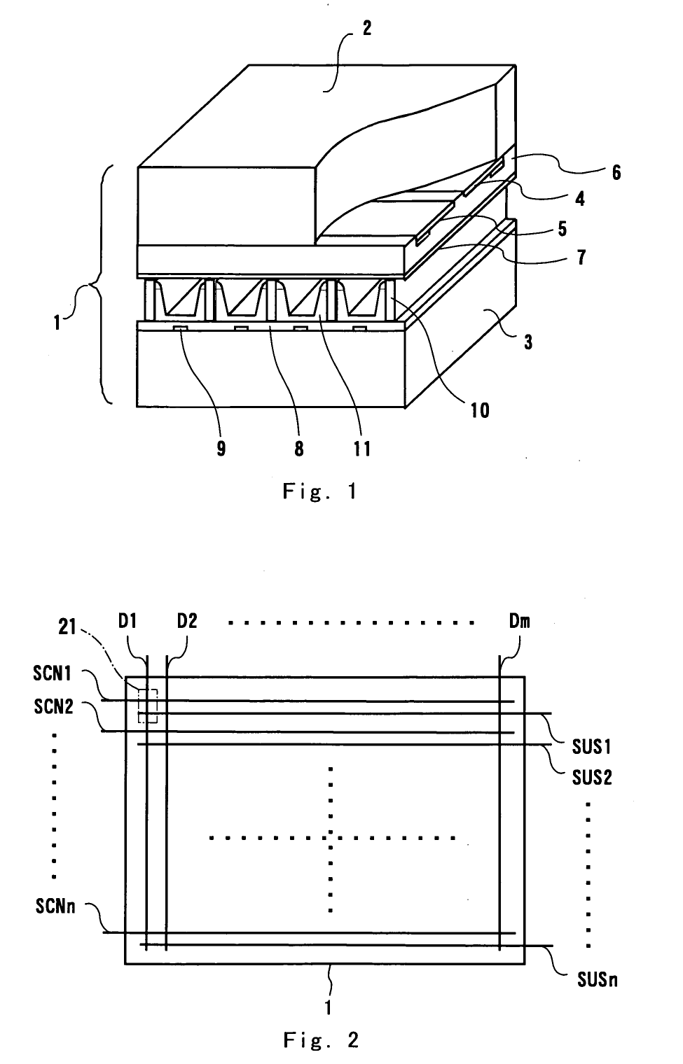

FIG. 1 is a perspective view showing main portions of a plasma display panel used in a plasma display apparatus according to Embodiment 1 of the present invention.

A plasma display panel 1 (hereinafter referred to as “PDP 1”) is configured to dispose a glass front substrate 2 and a glass back substrate 3 such that their main surfaces are opposed to each other, and form a discharge space therebetween. A plurality of scan electrodes 4 and a plurality of sustain electrodes 5 are formed on the main surface of the front substrate 2 to be in parallel with each other. The scan electrode 4 and the sustain electrode 5 forms a pair and constitutes a pair of display electrodes. A dielectric layer 6 is formed to cover the scan electrodes 4 and the sustain electrodes 5, and a protective layer 7 is formed to cover the dielectric layer 6. To enable stable discharge, a material of the protective layer 7 desirably has high secondary electron emission coefficient and high sputter resistance, and one example of the protective layer 7 is an MgO thin film. A plurality of data electrodes 9 are formed on the main surface of the back substrate 3. An insulator layer 8 is formed on the data electrodes 9 to cover them. Partition walls 10 are formed on the insulator layer 8 to be in parallel with the data electrode 9, and each partition wall 10 is formed between the data electrodes 9. A phosphor layer 11 is formed on a surface of the insulator layer 8 and side surfaces of the partition walls 10. The front substrate 2 and the back substrate 3 are disposed to be opposed to each other such that the scan electrodes 4 and the sustain electrodes 5 intersect with the data electrodes 9. A discharge gas, such as helium, neon, xenon or mixture gas of these is filled in the discharge space formed between the front substrate 2 and the back substrate 3.

FIG. 2 is a diagram showing the arrangement of electrodes of the PDP 1 of FIG. 1. Here, n scan electrodes SCN1 to SCNn (scan electrodes 4 in FIG. 1) and n sustain electrodes SUS1 to SUSn (sustain electrodes 5 in FIG. 1) are alternately arranged in a row direction, and m data electrodes D1 to Dm (data electrodes 9 in FIG. 1) are arranged in a column direction. A region where one scan electrode SCNi and one sustain electrode SUSi (i=1 to n) forming a pair intersect with one data electrode Dj (j=1 to m) while sandwiching the discharge space and a region in the vicinity of the above region form one discharge cell 21 which contributes to image display. Therefore, each discharge cell 21 is configured to include a pair of display electrodes (the scan electrode SCNi and the sustain electrode SUSi), one data electrode, and the discharge space therebetween. The PDP 1 has m×n discharge cells 21.

In the PDP 1 configured as above, ultraviolet is generated by gas discharge in each discharge cell, and causes excitation emission of phosphor of the phosphor layer 11. Color display can be carried out by, for example, applying the phosphor layer 11 of red, green, or blue (RGB), which are light's three primary colors, to each discharge cell.

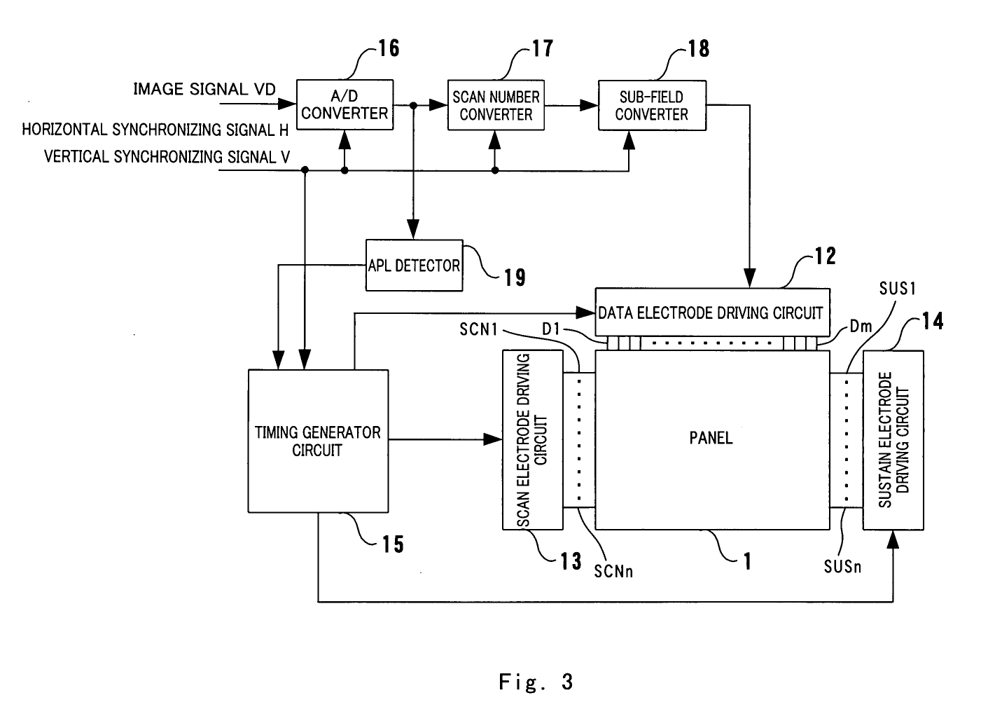

FIG. 3 is a block diagram showing the configuration of the plasma display apparatus according to Embodiment 1 of the present invention.

The plasma display apparatus according to the present embodiment includes the PDP 1 and a driving device of the PDP 1. The driving device is configured to include a data electrode driving circuit 12, a scan electrode driving circuit 13, a sustain electrode driving circuit 14, a timing generator circuit 15, an A/D (Analog/Digital) converter 16, a scan number converter 17, a sub-field converter 18, and an APL (Average Picture Level) detector 19.

In FIG. 3, a horizontal synchronizing signal H and a vertical synchronizing signal V are input to the timing generator circuit 15, the AD converter 16, the scan number converter 17, and the sub-field converter 18.

The timing generator circuit 15 generates timing signals of the driving circuits 12, 13, and 14 based on the horizontal synchronizing signal H and the vertical synchronizing signal V, and supplies the timing signals to the data electrode driving circuit 12, the scan electrode driving circuit 13, and the sustain electrode driving circuit 14. The data electrode driving circuit 12 drives the data electrodes D1 to Dm based on the supplied timing signal, the scan electrode driving circuit 13 drives the scan electrodes SCN1 to SCNn based on the supplied timing signal, and the sustain electrode driving circuit 14 drives the sustain electrodes SUS1 to SUSn based on the supplied timing signal.

An analog image signal VD is input to the A/D converter 16. The A/D converter 16 converts the analog image signal VD into a digital signal, i.e., image data, and outputs the image data to the scan number converter 17 and the APL detector 19. The APL detector 19 detects an average brightness level (APL) of the image data, and outputs the average brightness level to the timing generator circuit 15. The scan number converter 17 converts the supplied image data into image data corresponding to the number of pixels of the PDP 1, and outputs the image data to the sub-field converter 18. The sub-field converter 18 divides the image data of each pixel into a plurality of bits corresponding to a plurality of sub-fields forming one field, and outputs the image data of each sub-field to the data electrode driving circuit 12. The data electrode driving circuit 12 converts the image data of each sub-field into a signal corresponding to each data electrode D1 to Dm, and drives each data electrode D1 to Dm in the address period of the sub-field based on the signal.

The timing generator circuit 15 determines, based on the average brightness level output from the APL detector 19, which of an all-cell reset operation and a selective reset operation is carried out in each of the reset periods of the sub-fields forming one field. Thus, the timing generator circuit 15 limits the number of times the all-cell reset operation is carried out in one field. This configuration is known in the art (for example, Japanese Laid-Open Patent Application Publication No. 2005-326611, etc.), so that a detailed explanation thereof is omitted. In the present embodiment, which of the all-cell reset operation and the selective reset operation is carried out is determined based on the average brightness level of the image data. However, the present embodiment is not limited to this configuration. For example, the APL detector 19 may not be provided, and which of the all-cell reset operation and the selective reset operation is carried out may be predetermined for each reset period of the sub-field.

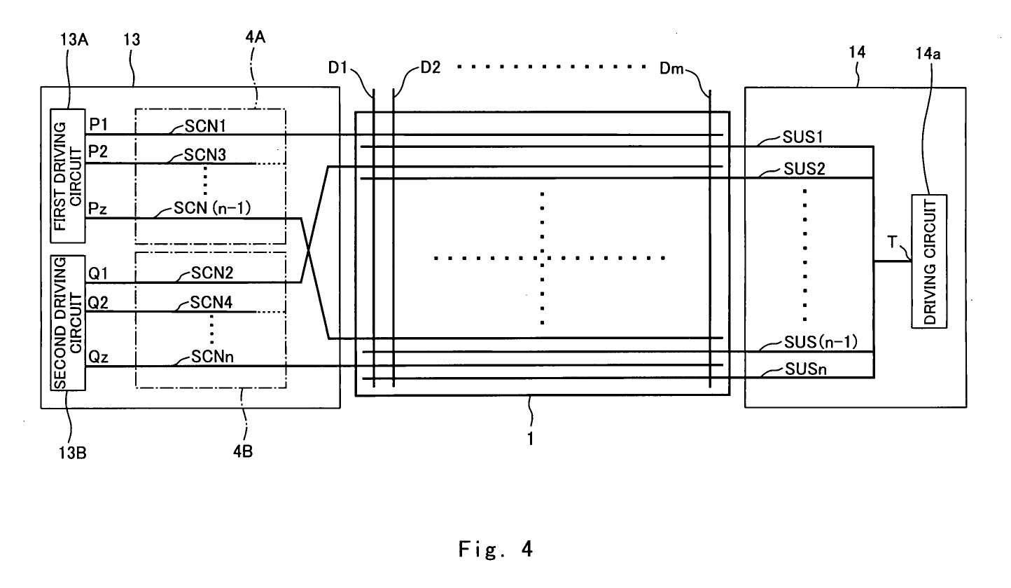

FIG. 4 is a diagram showing a relation of connection among the scan electrodes, the sustain electrodes, and respective driving circuits in Embodiment 1 of the present invention.

The scan electrodes SCN1 to SCNn are arranged within the PDP 1 in order of SCN1, SCN2, . . . , and SCNn in a direction from an upper end to a lower end of the PDP 1, and are extended to outside to be connected to the scan electrode driving circuit 13. Similarly, the sustain electrodes SUS1 to SUSn are arranged within the PDP 1 in order of SUS1, SUS2, . . . , and SUSn in a direction from the upper end to the lower end of the PDP 1, and are extended to outside to be connected to the sustain electrode driving circuit 14. Moreover, the data electrodes D1 to Dm which are arranged to intersect with the scan electrodes SCN1 to SCNn and the sustain electrodes SUS1 to SUSn are extended to outside to be connected to the data electrode driving circuit 12 (FIG. 3).

The scan electrode driving circuit 13 includes a first driving circuit 13A and a second driving circuit 13B. Moreover, in the scan electrode driving circuit 13, the scan electrodes SCN1 to SCNn are grouped into a scan electrode group 4A including the scan electrodes SCNa (a=1, 3, . . . , n−1) on odd-numbered rows and a scan electrode group 4B including the scan electrode SCNb (b=2, 4, . . . , n) on even-numbered rows. The scan electrodes SCNa of the group 4A are connected to the first driving circuit 13A which drives the scan electrodes SCNa, and the scan electrodes SCNb of the group 4B are connected to the second driving circuit 13B which drives the scan electrodes SCNb. Here, the first driving circuit 13A is provided with a plurality of output terminals P1, P2, . . . , and Pz (z=n/2), and the scan electrodes SCNa on the odd-numbered rows are respectively connected to these output terminals in order of arrangement of the scan electrodes SCNa (only the odd-numbered rows). Similarly, the second driving circuit 13B is provided with a plurality of output terminals Q1, Q2, . . . , and Qz, and the scan electrodes SCNb on the even-numbered rows are respectively connected to these output terminals in order of arrangement of the scan electrodes SCNb (only the even-numbered rows). Moreover, the scan electrode driving circuit 13 includes a control circuit (not shown) which controls the first driving circuit 13A and the second driving circuit 13B based on the timing signal supplied from the timing generator circuit 15.

In the sustain electrode driving circuit 14, all the sustain electrodes SUS1 to SUSn are connected to one another, and are connected to an output terminal T of a driving circuit 14a which drives the sustain electrodes SUS1 to SUSn. Moreover, the sustain electrode driving circuit 14 includes a control circuit (not shown) which controls the driving circuit 14a based on the timing signal supplied from the timing generator circuit 15.

Next, the method for driving the PDP of the present embodiment will be explained. In the present embodiment, this method for driving the PDP is carried out as an operation of the plasma display apparatus.

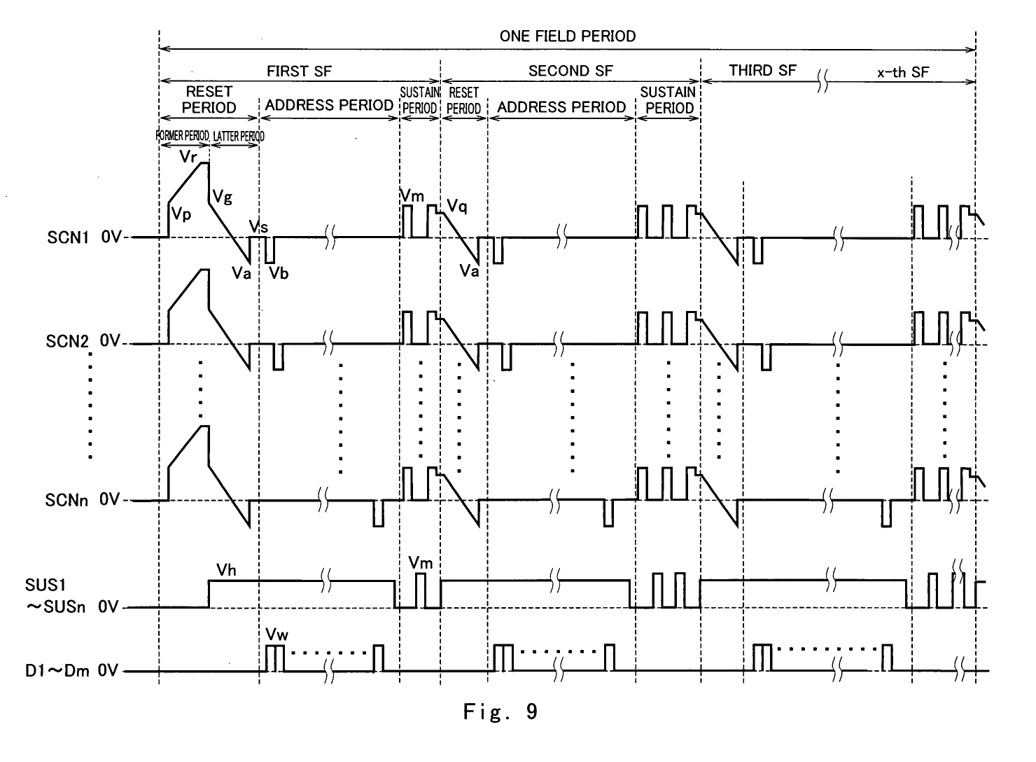

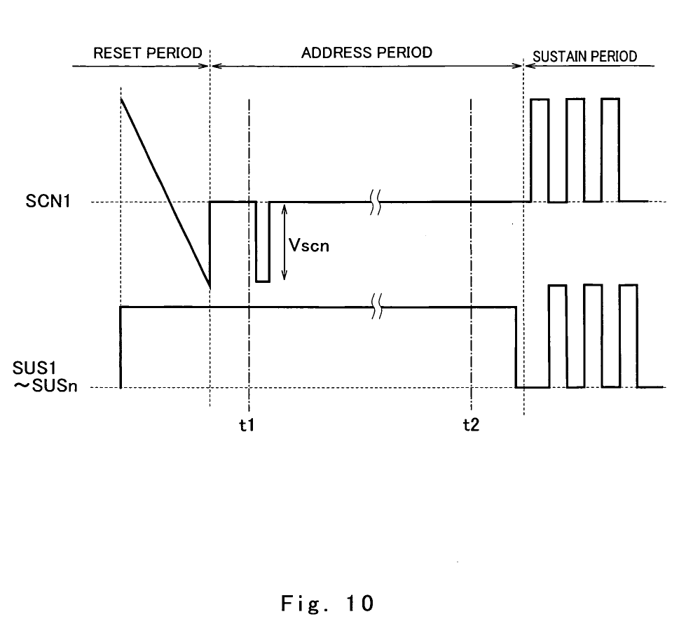

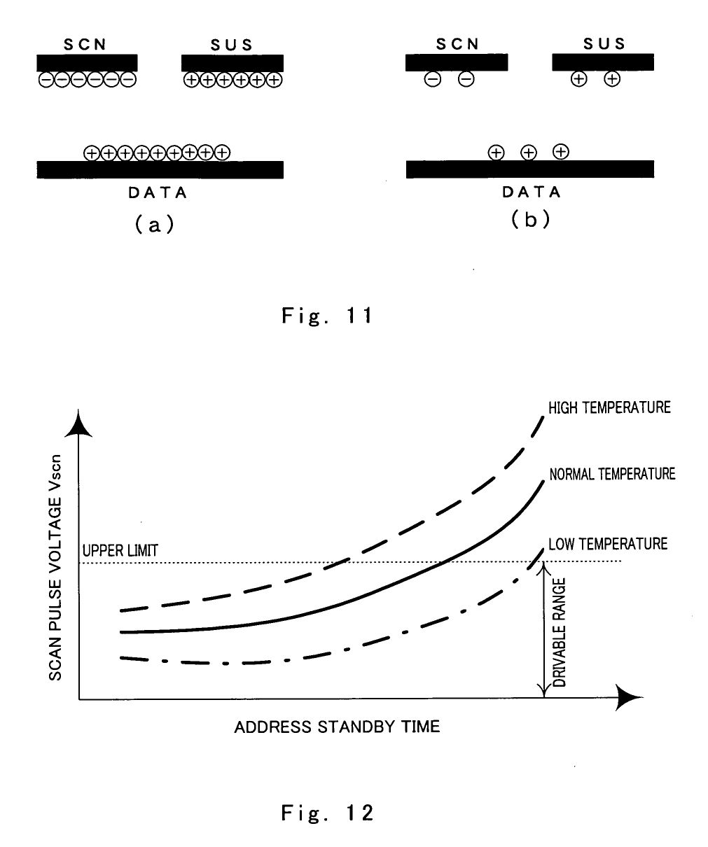

As with the conventional example, the method for driving the PDP of the present embodiment is the driving method using the sub-field method, and each sub-field includes the reset period, the address period, and the sustain period. Moreover, carried out in the reset period of a certain sub-field is any one of the all-cell reset operation in which all the discharge cells which carry out image display are caused to carry out the reset discharge and the selective reset operation in which only the discharge cells which have lit in the sustain period of an immediately preceding sub-field of the above certain sub-field are selectively caused to carry out the reset discharge. With this, the inside of each discharge cell becomes such an electrically charged state that the address discharge can be carried out in the address period, i.e., the amount of wall electric charge suitable for carrying out the address discharge is obtained. The driving method in the reset period and the sustain period is the same as that in the conventional example shown in FIG. 9, but the driving method in the address period is different from that in the conventional example. Note that the wall electric charge is accumulated on the dielectric layer or the phosphor layer covering the electrodes.

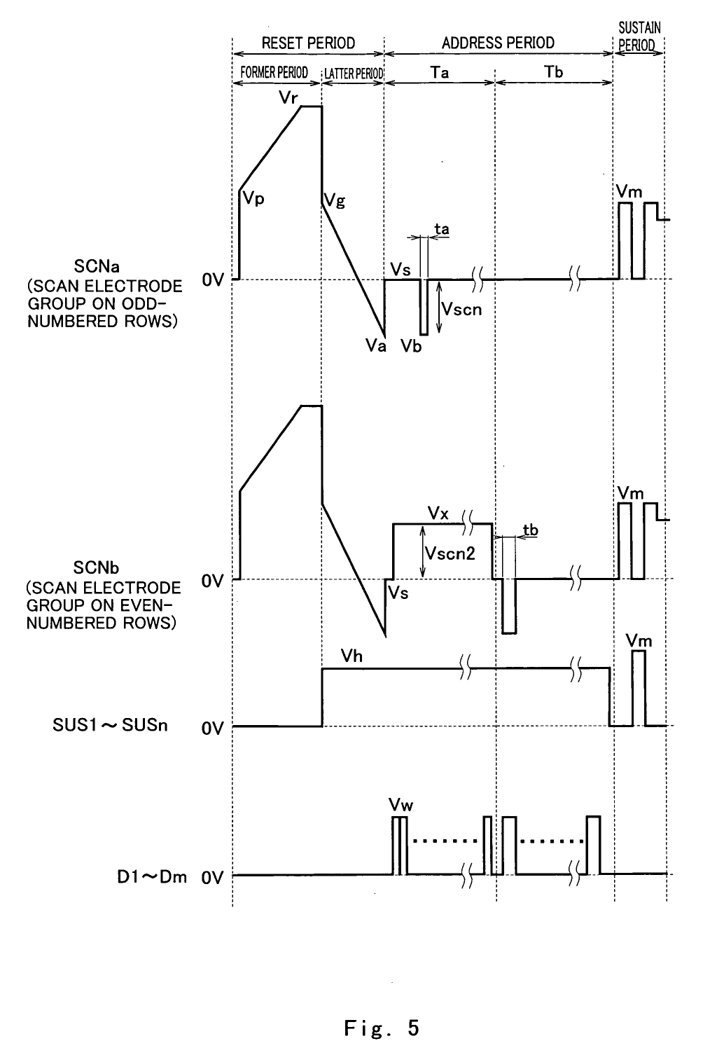

FIG. 5 is a waveform diagram of driving potential signals applied to respective electrodes in the method for driving the PDP of the present embodiment. FIG. 5 shows the driving potential signal of one of the scan electrodes SCNa of the scan electrode group 4A on the odd-numbered rows, the driving potential signal of one of the scan electrodes SCNb of the scan electrode group 4B on the even-numbered rows, the driving potential signal of the sustain electrodes SUS1 to SUSn, and the driving potential signal of the data electrode D1 to Dm in one sub-field period. In the reset period and the sustain period, the common scan electrode driving potential signal is supplied from the scan electrode driving circuit 13 to all the scan electrodes SCN1 to SCNn, and the common sustain electrode driving potential signal is supplied from the sustain electrode driving circuit 14 to all the sustain electrodes SUS1 to SUSn.

The all-cell reset operation is carried out in the reset period shown in FIG. 5. In the former period of the reset period, the sustain electrodes SUS1 to SUSn and the data electrodes D1 to Dm are held at 0 (V), and a lamp potential which gradually rises from a potential Vp (V) equal to or lower than a discharge start voltage to a potential Vr (V) exceeding the discharge start voltage is applied to the scan electrodes SCN1 to SCNn. This causes weak reset discharge in which the scan electrodes SCN1 to SCNn are anodes and the sustain electrodes SUS1 to SUSn and the data electrodes D1 to Dm are cathodes. Thus, first weak reset discharge is caused in all the discharge cells, so that negative wall electric charge is accumulated on the scan electrodes SCN1 to SCNn, and positive wall electric charge is accumulated on the sustain electrodes SUS1 to SUSn and the data electrodes D1 to Dm. The weak discharge in the former period of the reset period is caused in all the discharge cells regardless of whether or not the sustain discharge is caused in a preceding sub-field.

Next, in the latter period of the reset period, the sustain electrodes SUS1 to SUSn are held at a positive potential Vh (V), and a lamp potential which gradually drops from a potential Vg (V) to a potential Va (V) is applied to the scan electrodes SCN1 to SCNn. Thus, second weak reset discharge in which the scan electrodes SCN1 to SCNn are cathodes and the sustain electrodes SUS1 to SUSn and the data electrodes D1 to Dm are anodes is caused in all the discharge cells. Therefore, the wall electric charge excessively accumulated on the scan electrodes SCN1 to SCNn, the sustain electrodes SUS1 to SUSn, and the data electrodes D1 to Dm in the former period of the reset period is reduced, and the amount of wall electric charge is adjusted to be suitable for the address operation in the next address period.

As above, in the all-cell reset operation, the reset discharge is simultaneously carried out in all the discharge cells, the wall electric charge previously accumulated in each discharge cell is removed, and the wall electric charge necessary for the address operation is generated. Moreover, priming particles (priming for discharge, i.e., excited particles) for reducing discharge time lag and stably causing the address discharge are generated.

The address period includes a first sub-period Ta and a second sub-period Tb. The first sub-period Ta is an address sub-period assigned to the scan electrode group 4A on the odd-numbered rows, i.e., a period in which the address operation is carried out with respect to the discharge cells corresponding to the scan electrode group 4A. Moreover, the second sub-period Th is an address sub-period assigned to the scan electrode group 4B on the even-numbered rows, i.e., a period in which the address operation is carried out with respect to the discharge cells corresponding to the scan electrode group 4B. In the scan electrode groups 4A and 4B, for example, the address operation is carried out sequentially from the discharge cell corresponding to the scan electrode located on an upper side (on a small-numbered row) of the image to the discharge cell corresponding to the scan electrode located on a lower side (on a large-numbered row) of the image.

During the address period, all the sustain electrodes SUS1 to SUSn are maintained at the standby potential Vh (V) which has been held since the reset period. The standby potential Vh (V) is set to be higher than a first non-selective potential Vs (V) of the scan electrode and lower than a sustain pulse potential Vm (V) of the scan electrode.

In the first sub-period Ta, first, the scan electrodes SCN1 to SCNn are once held at the first non-selective potential Vs (V), and then, all the scan electrodes SCNb of the scan electrode group 4B are held at a second non-selective potential Vx (V) which is higher than the first non-selective potential Vs (V). Then, the address operation is carried out with respect to the discharge cells corresponding to the scan electrode group 4A on the odd-numbered rows. First, the address operation is carried out with respect to the discharge cells on the first row that is the first row corresponding to the scan electrode group 4A. In this address operation, the scan pulse potential Vb (V) that is a selective potential is applied to the scan electrode SCN1 on the first row, and the positive address pulse potential Vw (V) is applied to the data electrode Dk, among the data electrodes D1 to Dm, of the discharge cell which is caused to light on the first row. At this time, a voltage at an intersecting portion of the data electrode Dk and the scan electrode SCN1 is a voltage obtained by adding a voltage generated by the wall electric charge on the data electrode Dk and a voltage generated by the wall electric charge on the scan electrode SCN1 to an externally applied voltage (Vw-Vb), and as a result, exceeds the discharge start voltage. Then, the address discharge occurs between the data electrode Dk and the scan electrode SCN1 and between the sustain electrode SUS1 and the scan electrode SCN1, so that the positive wall electric charge is accumulated on the scan electrode SCN1 of the discharge cell, the negative wall electric charge is accumulated on the sustain electrode SUS1, and the negative wall electric charge is accumulated on the data electrode Dk. Thus, the address operation of generating the address discharge to accumulate the wall electric charge on respective electrodes is carried out in the discharge cell which is caused to light on the first row. In contrast, a voltage at an intersecting portion of the data electrode to which the positive address pulse potential Vw (V) is not applied and the scan electrode SCN1 does not exceed the discharge start voltage, so that the address discharge does not occur. Next, the address operation is carried out with respect to the discharge cells on the third row in the same manner as above. Thereafter, the address operation is sequentially carried out similarly up to the discharge cells on a (n−1)-th row that is the last row corresponding to the scan electrode group 4A. When the address operation with respect to the discharge cells on the (n−1)-th row is terminated, the potential of each of all the scan electrodes SCNb of the scan electrode group 4B is decreased from the second non-selective potential Vx (V) to the first non-selective potential Vs (V). Thus, the first sub-period Ta is terminated.

Next, in the second sub-period Th, the address operation is carried out with respect to the discharge cells corresponding to the scan electrode group 4B on the even-numbered rows. First, the address operation is carried out with respect to the discharge cells on the second row that is the first row corresponding to the scan electrode group 4B. The address operation with respect to the discharge cells on the second row is similar to the address operation with respect to the discharge cells on the first row described above (however, as will be described later, one-line address times ta and tb are different from each other). Next, the address operation with respect to the discharge cells on the fourth row is carried out in the same manner as above. Thereafter, the address operation is sequentially carried out similarly up to the discharge cells on the n-th row that is the last row corresponding to the scan electrode group 4B. When the address operation with respect to the discharge cells on the n-th row is terminated, all the sustain electrodes SUS1 to SUSn are held at 0 V. Thus, the second sub-period Th is terminated.

As above, in the address period in the present embodiment, after the address operation is carried out with respect to the discharge cells on the rows corresponding to the scan electrode group 4A, the address operation is carried out with respect to the discharge cells on the rows corresponding to the scan electrode group 4B. In respective address operations, the scan pulse is sequentially applied to the scan electrodes, and the address pulse potential corresponding to the image signal to be displayed is applied to the data electrodes. This selectively causes the address discharge between the scan electrode and the data electrode and between the scan electrode and the sustain electrode. Thus, the wall electric charge is selectively generated.

Further, in the present embodiment, the one-line address time that is a time during which the scan pulse potential Vb (V) is applied to each scan electrode is set to be different between the first sub-period Ta and the second sub-period Th. To be specific, the one-line address time ta in the first sub-period Ta is set to be shorter than the one-line address time tb in the second sub-period Th. In the first sub-period Ta as compared to the second sub-period Tb, the elapsed time since the termination of the reset period is short, and the reduction in the wall electric charge and the priming particles in the discharge cell is small. Therefore, the discharge time lag is small, and satisfactory address discharge can be obtained even if the one-line address time ta is set to be short. By setting the one-line address time ta to be short, the first sub-period Ta can be shortened. Moreover, the amount of neutralization of the wall electric charge in the address period becomes larger in the discharge cell which requires longer time (address standby time) from the termination of the reset period to the start of the address operation. In addition, the neutralization phenomenon of the wall electric charge occurs significantly immediately after the termination of the reset period due to, for example, mass generation of the priming particles by the reset discharge. Therefore, by setting the first sub-period Ta to be short, it is possible to suppress the reduction in the wall electric charge and the priming particles during the address standby of the discharge cell which is subjected to the address operation in the first sub-period Ta. Thus, it is possible to further prevent the address error in the latter period of the first sub-period Ta. Moreover, by setting the first sub-period Ta to be short, the second sub-period Th can be moved closer to the time of the termination of the reset period, and it is possible to suppress the reduction in the wall electric charge and the priming particles during the address standby of the discharge cell which is subjected to the address operation in the second sub-period Th. Thus, it is possible to prevent the address error in the second sub-period Th.

Next, in the sustain period, first, the sustain electrodes SUS1 to SUSn are returned to 0 (V), and the positive sustain pulse potential Vm (V) is applied to the scan electrodes SCN1 to SCNn. At this time, in the discharge space of the discharge cell in which the address discharge is caused, a voltage between a portion in the vicinity of the scan electrode SCNi and a portion in the vicinity of the sustain electrode SUSi becomes a voltage obtained by adding a voltage generated by the wall electric charge on the scan electrode SCNi and a voltage generated by the wall electric charge on the sustain electrode SUSi to a sustain pulse voltage (Vm), and exceeds the discharge start voltage. Then, the sustain discharge occurs between the scan electrode SCNi and the sustain electrode SUSi, so that the negative wall electric charge is accumulated on the scan electrode SCNi, and the positive wall electric charge is accumulated on the sustain electrode SUSi. At this time, the positive wall electric charge is accumulated also on the data electrode Dk. The sustain discharge does not occur in the discharge cell in which the address discharge did not occur in the address period. Next, the scan electrodes SCN1 to SCNn are returned to 0 (V), and the positive sustain pulse potential Vm (V) is applied to the sustain electrodes SUS1 to SUSn. With this, in the discharge space of the discharge cell in which the sustain discharge is caused, the voltage between the portion in the vicinity of the sustain electrode SUSi and the portion in the vicinity of the scan electrode SCNi exceeds the discharge start voltage. Therefore, the sustain discharge occurs again between the sustain electrode SUSi and the scan electrode SCNi, so that the negative wall electric charge is accumulated on the sustain electrode SUSi, and the positive wall electric charge is accumulated on the scan electrode SCNi. As above, by alternately applying the sustain pulse to the scan electrodes SCN1 to SCNn and the sustain electrodes SUS1 to SUSn, the discharge cell in which the address discharge has occurred in the address period continuously carries out the sustain discharge and thus lights. At this time, the number of times of the sustain pulse application corresponds to the degree of the brightness. Therefore, by setting the number of the sustain pulses to be different among respective sub-fields and by combining them, desired gray scale is realized. The sustain discharge is stopped by a pulse (narrow pulse) applied to the scan electrodes SCN1 to SCNn at the end of the sustain period. Thus, the sustain period is terminated. As above, in the sustain period, the sustain pulse voltage is applied between the scan electrode and the sustain electrode a predetermined number of times corresponding to the degree of the brightness, the discharge cell in which the wall electric charge is generated by the address discharge is selectively discharged, and is caused to emit light (to light).

Next, an operation in the sub-field in which the selective reset operation is carried out in the reset period will be explained.

This reset period is not shown in the drawings, but is similar to, for example, the reset period of the second SF in FIG. 9. To be specific, the sustain electrodes SUS1 to SUSn are held at Vh (V), the data electrodes D1 to Dm are held at 0 (V), and the lamp potential gradually dropping from Vq (V) to Va (V) is applied to the scan electrodes SCN1 to SCNn. With this, the weak reset discharge in which the scan electrodes SCN1 to SCNn are cathodes and the sustain electrodes SUS1 to SUSn and the data electrodes D1 to Dm are anodes is caused in the discharge cell in which the sustain discharge has occurred in the sustain period of the immediately preceding sub-field, so that excessive wall electric charge on the scan electrode SCNi, the sustain electrode SUSi, and the data electrode Dk is reduced to be adjusted to the amount of the wall electric charge suitable for the address operation. In contrast, the discharge is not caused in the discharge cell in which the address discharge or the sustain discharge did not carried out in the immediately preceding sub-field.

The address period and the sustain period after the above reset period are similar to the address period and the sustain period in the sub-field in which the all-cell reset operation is carried out in the reset period, so that explanations thereof are omitted.

The present embodiment is configured such that the standby potential Vh (V) applied to the sustain electrodes SUS1 to SUSn in the address period is equal to the positive potential Vh (V) applied in the reset period. However, the present embodiment is not limited to this configuration. For example, the present embodiment may be configured such that the standby potential Vh (V) applied in the address period is slightly higher (for example, about 5 to 20 V) than the positive potential applied in the reset period.

In the present embodiment, in the first sub-period Ta of the address period, the second non-selective potential Vx (V) applied to all the scan electrodes SCNb of the scan electrode group 4B is set to be higher than the first non-selective potential Vs (V) by a voltage Vscn2, and the voltage Vscn2 is set to be equal to the scan pulse voltage Vscn. The second non-selective potential Vx (V) may be set to be higher than the first non-selective potential Vs (V) and lower than the highest potential Vr (V) which is the highest in the reset period in which the all-cell reset operation is carried out. Note that the second non-selective potential Vx (V) is set such that the discharge does not occur between the scan electrode SCNb and the sustain electrode SUSb and between the scan electrode SCNb and the data electrode D1 to Dm.

In the above driving method, the operations in the reset period and the sustain period are similar to those in the conventional example shown in FIG. 9. To be specific, all the data electrodes D1 to Dm are held at the same potential (0 V for example) by the data electrode driving circuit 12, all the scan electrodes SCN1 to SCNn are driven in the same manner by the first and second driving circuits 13A and 13B of the scan electrode driving circuit 13, and all the sustain electrodes SUS1 to SUSn are driven in the same manner by the sustain electrode driving circuit 14. In addition, in the address period, the sustain electrodes SUS1 to SUSn are driven in the same manner as the conventional example shown in FIG. 9.

Moreover, the order of selection of the rows (order of selection of the scan electrodes) subjected to the address operation in the address period is prestored in the data electrode driving circuit 12, or the data electrode driving circuit 12 is configured to operate in accordance with the order of selection of the rows. When the data electrode driving circuit 12 converts the image data of each sub-field input from the sub-field converter 18 into a signal corresponding to each of the data electrodes D1 to Dm, it converts into the signal (address signal) corresponding to each of the data electrodes D1 to Dm in accordance with the order of selection of the rows subjected to the address operation, and supplies the signal to each of the data electrodes D1 to Dm. Moreover, the data electrode driving circuit 12 is configured to supply the address signal to each of the data electrodes D1 to Dm in sync with the selection of the scan electrode by the scan electrode driving circuit 13. A time during which the address signal is supplied in the first sub-period Ta corresponds to the one-line address time ta that is a time during which the scan electrode is selected, and a time during which the address signal is supplied in the second sub-period Tb corresponds to the one-line address time tb.

Moreover, the scan electrode driving circuit 13 is configured to cause the first driving circuit 13A to sequentially select the scan electrode for each first address cycle (one-line address time ta+time between the scan pulses) in the first sub-period Ta of the address period and to cause the second driving circuit 13B to sequentially select the scan electrode for each second address cycle (one-line address time tb+time between the scan pulses) in the second sub-period Th of the address period. In addition, the scan electrode driving circuit 13 is configured to apply the second non-selective potential Vx (V) to all the scan electrodes SCNb of the scan electrode group 4B from the second driving circuit 13B in the first sub-period Ta. Since the one-line address time ta is set to be shorter than the one-line address time tb, the first address cycle is shorter than the second address cycle. Moreover, by shortening the time between the scan pulses, the first address cycle can be set to substantially the one-line address time ta, and the second address cycle can be set to substantially the one-line address time tb. Further, by setting the time between the scan pulses to 0, the first address cycle can be set to be equal to the one-line address time ta, and the second address cycle can be set to be equal to the one-line address time tb.

In the first sub-period Ta of the address period, the first driving circuit 13A of the scan electrode driving circuit 13 sequentially applies the scan pulse potential Vb (V) to the output terminals P1, P2, . . . , and Pz in the order of arrangement. With this, the scan electrodes SCNa on the odd-numbered rows are selected in a predetermined order of selection (which is the same as the order of arrangement of the odd-numbered rows in the PDP 1 in the present embodiment). Moreover, in the second sub-period Th, the second driving circuit 13B sequentially applies the scan pulse potential Vb (V) to the output terminals Q1, Q2, . . . , and Qz in the order of arrangement. With this, the scan electrodes SCNb on the even-numbered rows are selected in a predetermined order of selection (which is the same as the order of arrangement of the even-numbered rows in the PDP 1 in the present embodiment). As above, since the scan electrodes are selected in a predetermined order of selection which is different from the order of arrangement of all the scan electrodes in the PDP 1, the first driving circuit 13A and the second driving circuit 13B may sequentially apply the scan pulse potential Vb (V) in order of arrangement of the output terminals. Therefore, the first driving circuit 13A and the second driving circuit 13B are simplified in configuration.

As above, the scan electrode driving circuit 13 is configured to select the scan electrode in a predetermined order of selection when carrying out the address operation of the address period.

Moreover, the sustain electrode driving circuit 14 is configured to apply the common (same) standby potential Vh (V) to all the sustain electrodes SUS1 to SUSn in the address period continuously from the reset period.

As is clear from the above-described operation, in the scan electrode driving circuit 13, the second driving circuit 13B which drives the scan electrodes SCNb of the scan electrode group 4B is configured by adding to the first driving circuit 13A a configuration which applies the second non-selective potential Vx (V) to all the scan electrodes SCNb of the scan electrode group 4B in the first sub-period Ta.

In the present embodiment, the address period after the reset period is divided into a plurality of sub-periods, and the second non-selective potential Vx (V) higher than the first non-selective potential Vs (V) is applied in the first sub-period Ta to the scan electrodes SCNb of the scan electrode group 4B assigned to the second sub-period Th after the first sub-period Ta. With this, in the discharge cell (discharge cell corresponding to the scan electrode group 4B) which is standing by for addressing, a potential difference between a portion in the vicinity of the scan electrode SCNb and a portion in the vicinity of the data electrode D1 to Dm in the discharge space and a potential difference between the portion in the vicinity of the scan electrode SCNb and a portion in the vicinity of the sustain electrode SUSb is reduced. Thus, it is possible to suppress the neutralization of the wall electric charge, which was the conventional problem. Further, by setting the one-line address time ta in the first sub-period Ta to be shorter than the one-line address time tb in the second sub-period Tb, the first sub-period Ta can be shortened, so that the latter period of the first sub-period Ta and the second sub-period Tb can be moved closer to the time of the termination of the reset period. Thus, it is possible to suppress the reduction in the wall electric charge and the priming particles during the address standby of the discharge cell which is subjected to the address operation in the latter period of the first sub-period Ta and in the second sub-period Tb. With this, the electrically charged state in which the address discharge can be carried out at the time of termination of the reset period can be maintained more satisfactorily, and it is possible to further reduce the address error caused due to the increase in the address standby time.

Further, since the scan electrodes of the scan electrode group 4A and the scan electrodes of the scan electrode group 4B are alternately arranged in the PDP 1, the scan electrodes belonging to the scan electrode groups 4A and 4B exist uniformly on the entire panel surface (image) of the PDP 1. Therefore, the brightness difference generated on the image due to, for example, the difference of the circuit impedance between the scan electrode groups 4A and 4B and the difference of load between the scan electrode groups 4A and 4B becomes unnoticeable, and the generation of bright lines and dark lines can be prevented. Thus, satisfactory image quality can be obtained.

### MODIFICATION EXAMPLE

Next, Modification Example of Embodiment 1 will be explained. In Modification Example, only the driving method in the address period is different from that in FIG. 5.

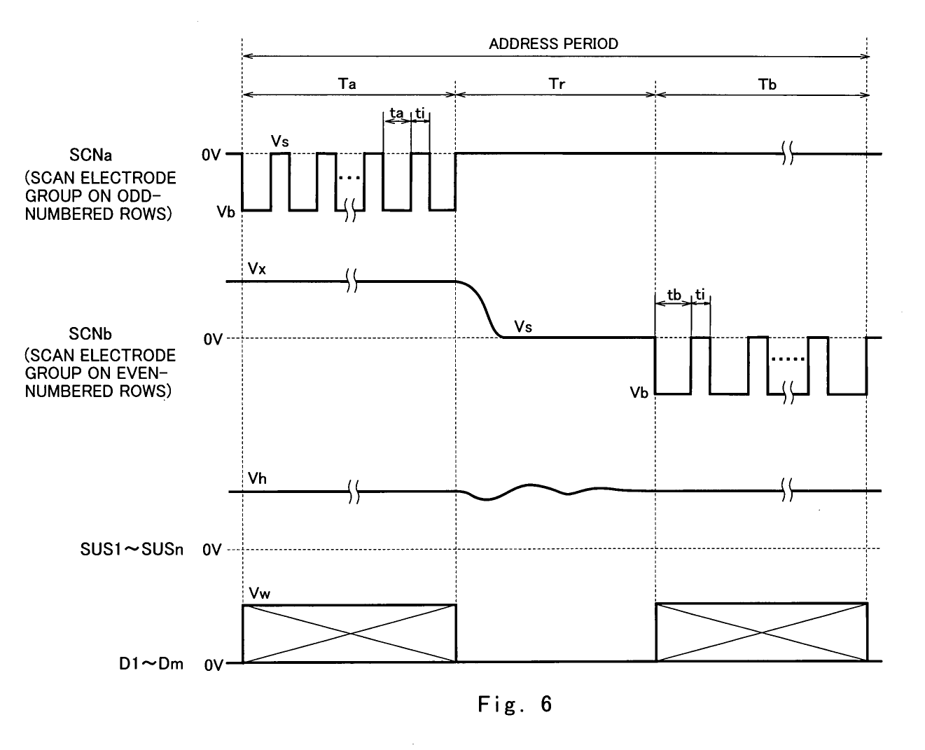

FIG. 6 is a waveform diagram showing potentials of respective electrodes in the address period in Modification Example of Embodiment 1. FIG. 6 shows the potential of the scan electrode SCNa on the odd-numbered row, the potential of the scan electrode SCNb on the even-numbered row, the potential of the sustain electrode SUS1 to SUSn, and the potential of the data electrode D1 to Dm in the address period. Note that FIG. 6 shows the scan pulse (potential Vb) sequentially applied to all the scan electrodes SCNa on the odd-numbered rows, and the scan pulse (potential Vb) sequentially applied to all the scan electrodes SCNb on the even-numbered rows. Moreover, an individual form of the address pulse (potential Vw) applied to the data electrodes D1 to Dm is the same as that in FIG. 5, so that it is not shown in FIG. 6, but only a period in which the address pulse is applied is shown in FIG. 6.

In Modification Example, the address period includes the first sub-period Ta, an address stop period Tr, and the second sub-period Tb. As with FIG. 5, the first sub-period Ta is a period in which the address operation is carried out with respect to the discharge cells corresponding to the scan electrode group 4A. Moreover, as with FIG. 5, the second sub-period Th is a period in which the address operation is carried out with respect to the discharge cells corresponding to the scan electrode group 4B.

The address stop period Tr is provided between the first sub-period Ta and the second sub-period Th. The scan pulse and the address pulse are not applied in the address stop period Tr. In the address stop period Tr, the potential applied to the scan electrodes SCNb of the scan electrode group 4B is switched from the second non-selective potential Vx (V) to the first non-selective potential Vs (V). At this time, as shown in FIG. 6, the potential of the scan electrode SCNb of the scan electrode group 4B does not change steeply, and a predetermined time (transition time) is required until the potential of the scan electrode SCNb reaches the first non-selective potential Vs. Moreover, at this time, the potential of the sustain electrode SUS1 to SUSn changes as shown in FIG. 6 by capacitive coupling to the scan electrodes SCNb on the even-numbered rows.

As above, in a case where the predetermined time is required to switch the potential of the scan electrode SCNb to the first non-selective potential Vs, and the potential of the sustain electrode SUS1 to SUSn changes, for example, when the address stop period Tr is not provided and an interval between the last scan pulse of the scan electrode group 4A on the odd-numbered rows and the first scan pulse of the scan electrode group 4B on the even-numbered rows is set to be equal to a scan pulse interval (time between the scan pulses) ti at the time of normal addressing, the potential of the scan electrode SCNb on the even-numbered row needs to become the first non-selective potential Vs by the time the first scan pulse is applied to the scan electrode SCNb on the even-numbered row. Therefore, in this case, when or before the last scan pulse is applied to the scan electrode group 4A on the odd-numbered rows, the potential applied to the scan electrode SCNb on the even-numbered row needs to be switched from the second non-selective potential Vx (V) to the first non-selective potential Vs (V). In this case, when the last scan pulse is applied to the scan electrode group 4A on the odd-numbered rows, the potential of the sustain electrode SUS1 to SUSn changes as described above. To be specific, the potential of the sustain electrode SUS (n−1) which forms a pair with the scan electrode SCN (n−1) to which the last scan pulse of the scan electrode group 4A is applied changes, and this changes the potential of the scan electrode SCN (n−1) to which the scan pulse is applied. With this, the voltage between the scan electrode SCN (n−1) and the sustain electrode SUS (n−1) decreases, so that the address error is more likely to occur.

In Modification Example, the address stop period Tr is provided after the last scan pulse is applied to the scan electrode group 4A on the odd-numbered row, i.e., after the first sub-period Ta, the potential applied to the scan electrode SCNb on the even-numbered row is switched in the address stop period Tr, and the second sub-period Th is started after the change of the potential of the sustain electrode SUS1 to SUSn is terminated or substantially terminated. With this, the above-described address error can be prevented.

The address stop period Tr is longer than at least the scan pulse interval ti in the sub-periods Ta and Th, and is determined such that one field including a plurality of sub-fields is within a predetermined time (for example, about 16.7 ms when the frequency is 60 Hz). For example, obtained by using a simulation or a trial product is a time (referred to as a time ts) that elapses until the potential of the sustain electrode SUS1 to SUSn reaches a predetermined value within Vh±1 (V) (until the change of the potential substantially terminates) when the potential applied to the scan electrode SCNb on the even-numbered row is switched from the second non-selective potential Vx (V) to the first non-selective potential Vs (V), and the time ts may be set as a time of the address stop period Tr. In this case, as shown in FIG. 6, the potential applied to the scan electrode SCNb on the even-numbered row is switched immediately after the termination of the first sub-period Ta, i.e., simultaneously with the start of the address stop period Tr. Moreover, in a case where the address stop period Tr can be set to be longer than the time ts, the address stop period Tr may be set to be longer than the time ts in such a manner that the timing for switching the potential applied to the scan electrode SCNb on the even-numbered row is delayed by the corresponding time, and the potential applied to the scan electrode SCNb in the former half period of the address stop period Tr is switched. In FIG. 6, for example, the one-line address time ta, tb may be set to a predetermined value in a range from 1.3 to 1.45 μs (ta<tb), the scan pulse interval ti may be set to a predetermined value in a range from 0.1 to 0.25 μs, and the address stop period Tr may be set to a predetermined value in a range from 7.25 to 14.5 μs.

### Embodiment 2

The plasma display panel used in the plasma display apparatus according to Embodiment 2 of the present invention is similar in configuration to that according to Embodiment 1 shown in FIGS. 1 and 2, so that an explanation thereof is omitted.

Moreover, the block diagram showing the schematic configuration of the plasma display apparatus according to Embodiment 2 of the present invention is also shown by FIG. 3 used in Embodiment 1, but the internal configuration of the sustain electrode driving circuit 14 in the present embodiment is different from that in Embodiment 1. Embodiment 2 is similar in configuration to Embodiment 1 except for the sustain electrode driving circuit 14, so that a detailed explanation thereof is omitted.

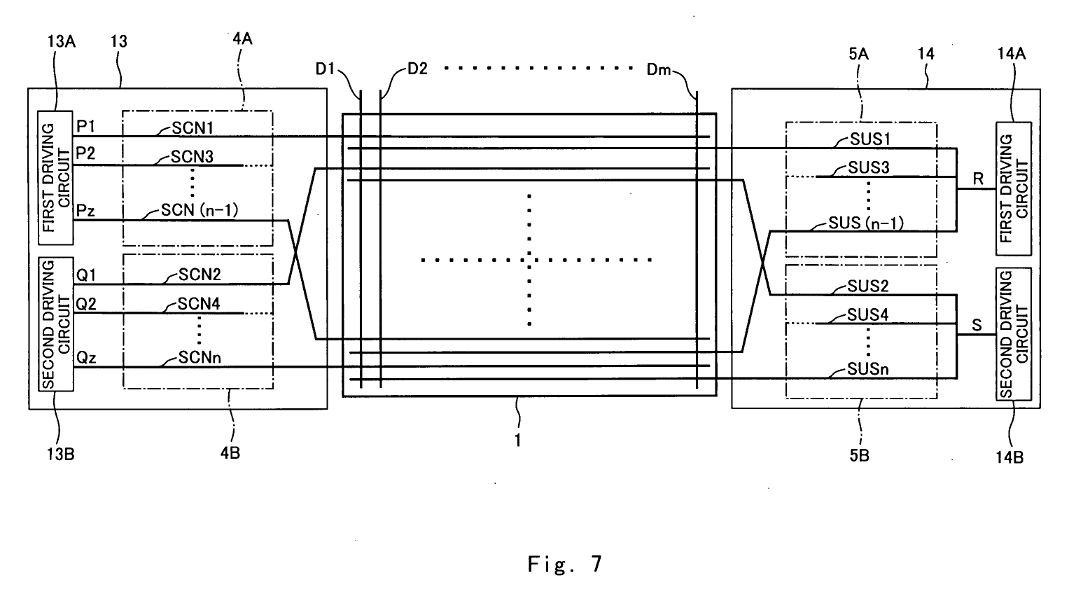

FIG. 7 is a diagram showing a relation of connection among the scan electrodes, the sustain electrodes, and respective driving circuits in Embodiment 2 of the present invention.

The PDP 1 herein has the same configuration as that in Embodiment 1. In the PDP 1, the scan electrodes SCN1 to SCNn, the sustain electrodes SUS1 to SUSn, and the data electrodes D1 to Dm are arranged.

The scan electrode driving circuit 13 herein has the same configuration as that in Embodiment 1, and includes the first driving circuit 13A which drives the scan electrodes SCNa (a=1, 3, . . . , n−1) of the scan electrode group 4A on the odd-numbered rows, the second driving circuit 13B which drives the scan electrodes SCNb (b=2, 4, . . . , n) of the scan electrode group 4B on the even-numbered rows, and a control circuit (not shown) which controls these circuits 13A and 13B.

The sustain electrode driving circuit 14 is different from that in Embodiment 1, and includes a first driving circuit 14A and a second driving circuit 14B. In the sustain electrode driving circuit 14, the sustain electrodes SUS1 to SUSn are grouped into a sustain electrode group 5A including the sustain electrodes SUSa (a=1, 3, . . . , n−1) on the odd-numbered rows and a sustain electrode group 5B including the sustain electrode SUSb (b=2, 4, . . . , n) on the even-numbered rows. The sustain electrodes SUSa of the group 5A are connected to one another, and are connected to an output terminal R of the first driving circuit 14A which drives the sustain electrodes SUSa, and the sustain electrodes SUSb of the group 5B are connected to one another, and are connected to an output terminal S of the second driving circuit 14B which drives the sustain electrodes SUSb. Moreover, the sustain electrode driving circuit 14 includes a control circuit (not shown) which controls the first driving circuit 14A and the second driving circuit 14B based on the timing signal supplied from the timing generator circuit 15.

Here, the sustain electrode group 5A is a group of the sustain electrodes SUSa which form pairs with the scan electrodes SCNa of the group 4A, and the sustain electrode group 5B is a group of the sustain electrodes SUSb which form pairs with the scan electrodes SCNb of the group 4B. Therefore, the sustain electrode group 5A corresponds to the scan electrode group 4A, and the sustain electrode group 5B corresponds to the scan electrode group 4B.

Next, the method for driving the PDP in the present embodiment will be explained. In the present embodiment, this method for driving the PDP is carried out as an operation of the plasma display apparatus.

As with the conventional example and Embodiment 1, the method for driving the PDP of the present embodiment is the driving method using the sub-field method, and each sub-field includes the reset period, the address period, and the sustain period. Moreover, carried out in the reset period of a certain sub-field is any one of the all-cell reset operation by which all the discharge cells which carry out image display are caused to carry out the reset discharge and the selective reset operation by which only the discharge cells which have lit in the sustain period of an immediately preceding sub-field of the above certain sub-field are selectively caused to carry out the reset discharge. With this, the inside of each discharge cell becomes such an electrically charged state that the address discharge can be carried out in the address period, i.e., the amount of wall electric charge suitable for carrying out the address discharge is obtained. The driving method in the reset period and the sustain period is the same as that in the conventional example shown in FIG. 9 and that in Embodiment 1 shown in FIG. 5, but the driving method in the address period is different from that in the conventional example and that in Embodiment 1.

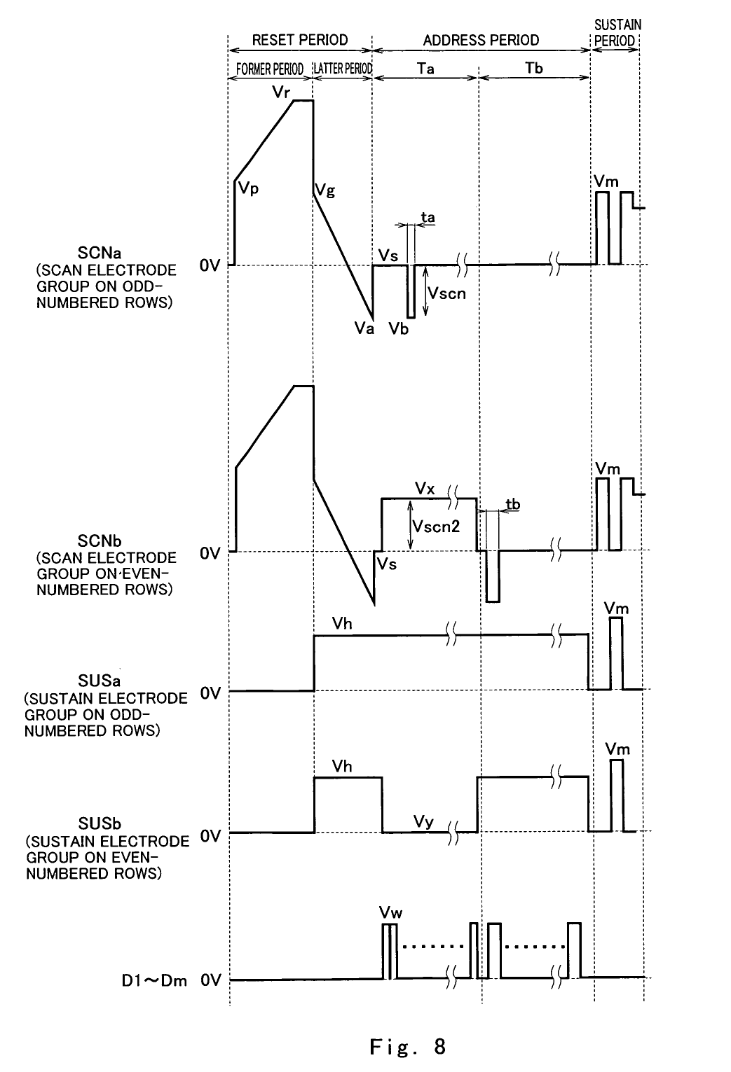

FIG. 8 is a waveform diagram of the driving potential signals applied to respective electrodes in the method for driving the PDP in the present embodiment. FIG. 8 shows the driving potential signal of one of the scan electrodes SCNa of the scan electrode group 4A on the odd-numbered rows, the driving potential signal of one of the scan electrodes SCNb of the scan electrode group 4B on the even-numbered rows, the driving potential signal of the sustain electrode SUSa of the sustain electrode group 5A on the odd-numbered row, the driving potential signal of the sustain electrode SUSb of the sustain electrode group 5B on the even-numbered row, and the driving potential signal of the data electrode D1 to Dm in one sub-field period. In the reset period and the sustain period, the common scan electrode driving potential signal is supplied from the scan electrode driving circuit 13 to all the scan electrodes SCN1 to SCNn, and the common sustain electrode driving potential signal is supplied from the sustain electrode driving circuit 14 to all the sustain electrodes SUS1 to SUSn.

In FIG. 8, the operation in the reset period in which the all-cell reset operation is carried out and the operation in the sustain period are similar to those in Embodiment 1 shown in FIG. 5, so that explanations thereof are omitted.

The address period includes the first sub-period Ta and the second sub-period Th. The first sub-period Ta is an address sub-period assigned to the scan electrode group 4A on the odd-numbered rows, i.e., a period in which the address operation is carried out with respect to the discharge cells corresponding to the scan electrode group 4A. Moreover, the second sub-period Th is an address sub-period assigned to the scan electrode group 4B on the even-numbered rows, i.e., a period in which the address operation is carried out with respect to the discharge cells corresponding to the scan electrode group 4B. In the scan electrode groups 4A and 4B, for example, the address operation is carried out sequentially from the discharge cell corresponding to the scan electrode located on an upper side (on a small-numbered row) of the image to the discharge cell corresponding to the scan electrode located on a lower side (on a large-numbered row) of the image.

In the first sub-period Ta, first, the scan electrodes SCN1 to SCNn are once held at the first non-selective potential Vs (V), and then, all the scan electrodes SCNb of the scan electrode group 4B are held at the second non-selective potential Vx (V) which is higher than the first non-selective potential Vs (V), and all the sustain electrodes SUSb of the sustain electrode group 5B are held at a second standby potential Vy (V) which is lower than the potential Vh (V) that is a first standby potential. Here, all the sustain electrodes SUSa of the sustain electrode group 5A are maintained at the potential Vh (V) that is the first standby potential which has been held since the reset period. Then, the address operation is carried out with respect to the discharge cells corresponding to the scan electrode group 4A on the odd-numbered rows. First, the address operation is carried out with respect to the discharge cells on the first row that is the first row corresponding to the scan electrode group 4A. In this address operation, the scan pulse potential Vb (V) that is the selective potential is applied to the scan electrode SCN1 on the first row, and the positive address pulse potential Vw (V) is applied to the data electrode Dk, among the data electrodes D1 to Dm, of the discharge cell which is caused to light on the first row. At this time, a voltage at an intersecting portion of the data electrode Dk and the scan electrode SCN1 is a voltage obtained by adding a voltage generated by the wall electric charge on the data electrode Dk and a voltage generated by the wall electric charge on the scan electrode SCN1 to an externally applied voltage (Vw-Vb), and as a result, exceeds the discharge start voltage. Then, the address discharge occurs between the data electrode Dk and the scan electrode SCN1 and between the sustain electrode SUS1 and the scan electrode SCN1, so that the positive wall electric charge is accumulated on the scan electrode SCN1 of the discharge cell, the negative wall electric charge is accumulated on the sustain electrode SUS1, and the negative wall electric charge is accumulated on the data electrode Dk. Thus, the address operation of generating the address discharge to accumulate the wall electric charge on respective electrodes is carried out in the discharge cell which is caused to light on the first row. In contrast, a voltage at an intersecting portion of the data electrode to which the positive address pulse potential Vw (V) is not applied and the scan electrode SCN1 does not exceed the discharge start voltage, so that the address discharge does not occur. Next, the address operation is carried out with respect to the discharge cells on the third row in the same manner as above. Thereafter, the address operation is sequentially carried out similarly up to the discharge cells on the (n−1)-th row that is the last row corresponding to the scan electrode group 4A. When the address operation with respect to the discharge cells on the (n−1)-th row is terminated, each of all the scan electrodes SCNb of the scan electrode group 4B is held at the first non-selective potential Vs (V), and each of all the sustain electrodes SUSb of the sustain electrode group 5B is held at the potential Vh (V) that is the first standby potential. Thus, the first sub-period Ta is terminated. Note that the first standby potential Vh (V) is set to be higher than the first non-selective potential Vs (V) of the scan electrode and lower than the sustain pulse potential Vm (V) of the scan electrode.

Next, in the second sub-period Th, all the sustain electrodes SUS1 to SUSn of the sustain electrode groups 5A and 5B are held at the potential Vh (V). Then, the address operation is carried out with respect to the discharge cells corresponding to the scan electrode group 4B on the even-numbered rows. First, the address operation is carried out with respect to the discharge cells on the second row that is the first row corresponding to the scan electrode group 4B. The address operation with respect to the discharge cells on the second row is similar to the address operation with respect to the discharge cells on the first row described above (however, as will be described later, the one-line address times ta and tb are different from each other). Next, the address operation with respect to the discharge cells on the fourth row is carried out in the same manner as above. Thereafter, the address operation is sequentially carried out similarly up to the discharge cells on the n-th row that is the last row corresponding to the scan electrode group 4B. When the address operation with respect to the discharge cells on the n-th row is terminated, all the sustain electrodes SUS1 to SUSn are held at 0 V. Thus, the second sub-period Tb is terminated.

As above, in the address period in the present embodiment, after the address operation is carried out with respect to the discharge cells on the rows corresponding to the scan electrode group 4A, the address operation is carried out with respect to the discharge cells on the rows corresponding to the scan electrode group 4B. In respective address operations, the scan pulse is sequentially applied to the scan electrodes, and the address pulse potential corresponding to the image signal to be displayed is applied to the data electrodes. This selectively causes the address discharge between the scan electrode and the data electrode and between the scan electrode and the sustain electrode. Thus, the wall electric charge is selectively generated.

Further, in the present embodiment, the one-line address time that is a time during which the scan pulse potential Vb (V) is applied to each scan electrode is set to be different between the first sub-period Ta and the second sub-period Th. To be specific, the one-line address time ta in the first sub-period Ta is set to be shorter than the one-line address time tb in the second sub-period Th. In the first sub-period Ta as compared to the second sub-period Tb, the elapsed time since the termination of the reset period is short, and the reduction in the wall electric charge and the priming particles in the discharge cell is small. Therefore, the discharge time lag is small, and satisfactory address discharge can be obtained even if the one-line address time ta is set to be short. By setting the one-line address time ta to be short, the first sub-period Ta can be shortened. Moreover, the amount of neutralization of the wall electric charge in the address period becomes larger in the discharge cell which requires longer time (address standby time) from the termination of the reset period to the start of the address operation. In addition, the neutralization phenomenon of the wall electric charge occurs significantly immediately after the termination of the reset period due to, for example, mass generation of the priming particles by the reset discharge. Therefore, by setting the first sub-period Ta to be short, it is possible to suppress the reduction in the wall electric charge and the priming particles during the address standby of the discharge cell which is subjected to the address operation in the first sub-period Ta. Thus, it is possible to further prevent the address error in the latter period of the first sub-period Ta. Moreover, by setting the first sub-period Ta to be short, the second sub-period Th can be moved closer to the time of the termination of the reset period, and it is possible to suppress the reduction in the wall electric charge and the priming particles during the address standby of the discharge cell which is subjected to the address operation in the second sub-period Tb. Thus, it is possible to prevent the address error in the second sub-period Th.

Next, the operation in the sub-field in which the selective reset operation is carried out in the reset period will be explained.

This reset period is not shown in the drawings, but is similar to, for example, the reset period of the second SF in FIG. 9, and is as explained in Embodiment 1. The address period and the sustain period after the above reset period are similar to the address period and the sustain period in the sub-field in which the all-cell reset operation is carried out in the reset period, so that explanations thereof are omitted.

The present embodiment is configured such that the first standby potential Vh (V) applied to the sustain electrodes SUS1 to SUSn in the address period is equal to the positive potential Vh (V) applied in the reset period. However, the present embodiment is not limited to this configuration. For example, the present embodiment may be configured such that the first standby potential Vh (V) applied in the address period is slightly higher (for example, about 5 to 20 V) than the positive potential applied in the reset period.

In the present embodiment, in the first sub-period Ta of the address period, the second non-selective potential Vx (V) applied to all the scan electrodes SCNb of the scan electrode group 4B is set to be higher than the first non-selective potential Vs (V) by the voltage Vscn2, and the voltage Vscn2 is set to be equal to the scan pulse voltage Vscn. The second non-selective potential Vx (V) may be set to be higher than the first non-selective potential Vs (V) and lower than the highest potential Vr (V) which is the highest in the reset period in which the all-cell reset operation is carried out. Note that the second non-selective potential Vx (V) is set such that the discharge does not occur between the scan electrode SCNb and the sustain electrode SUSb or between the scan electrode SCNb and the data electrode D1 to Dm.

Moreover, the second standby potential Vy (V) applied to all the sustain electrodes SUSb of the sustain electrode group 5B in the first sub-period Ta is set to a ground potential. The second standby potential Vy (V) may be set to be lower than the first standby potential Vh (V) and higher than the selective potential Vb (V) of the scan electrode. Note that the second standby potential Vy (V) is set such that the discharge does not occur between the sustain electrode SUSb and the scan electrode SCNb or between the sustain electrode SUSb and the data electrode D1 to Dm.

In the above driving method, the operations in the reset period and the sustain period are similar to those in the conventional example shown in FIG. 9. To be specific, all the data electrodes D1 to Dm are held at the same potential (0 V for example) by the data electrode driving circuit 12, all the scan electrodes SCN1 to SCNn are driven in the same manner by the first and second driving circuits 13A and 13B of the scan electrode driving circuit 13, and all the sustain electrodes SUS1 to SUSn are driven in the same manner by the first and second driving circuit 14a and 14B of the sustain electrode driving circuit 14.

Moreover, the sustain electrode driving circuit 14 is configured such that: the first driving circuit 14A applies the first standby potential Vh (V) to all the sustain electrodes SUSa of the sustain electrode group 5A during the address period continuously from the reset period; and the second driving circuit 14B applies to all the sustain electrodes SUSb of the sustain electrode group 5B the second standby potential Vy (V) in the first sub-period Ta of the address period and the first standby potential Vh (V) in the second sub-period Th of the address period.

As is clear from the above-described operation, in the scan electrode driving circuit 13, the second driving circuit 13B which drives the scan electrodes SCNb of the scan electrode group 4B is configured by adding to the first driving circuit 13A a component which applies the second non-selective potential Vx (V) to all the scan electrodes SCNb of the scan electrode group 4B in the first sub-period Ta (which is the same as Embodiment 1). Moreover, in the sustain electrode driving circuit 14, the second driving circuit 14B which drives the sustain electrodes SUSb of the sustain electrode group 5B is configured by adding to the first driving circuit 14A a component which applies the second standby potential Vy (V) to all the sustain electrodes SUSb of the sustain electrode group 5B in the first sub-period Ta.

In the present embodiment, the address period after the reset period is divided into a plurality of sub-periods, and the second non-selective potential Vx (V) higher than the first non-selective potential Vs (V) is applied in the first sub-period Ta to the scan electrodes SCNb of the scan electrode group 4B assigned to the second sub-period Th after the first sub-period Ta. With this, in the discharge cell (discharge cell corresponding to the scan electrode group 4B) which is standing by for addressing, the potential difference between the portion in the vicinity of the scan electrode SCNb and the portion in the vicinity of the data electrode D1 to Dm in the discharge space and the potential difference between the portion in the vicinity of the scan electrode SCNb and the portion in the vicinity of the sustain electrode SUSb is reduced. Thus, it is possible to suppress the neutralization of the wall electric charge, which was the conventional problem. Further, by applying to the sustain electrodes SUSb of the sustain electrode group 5B the second standby potential Vy (V) lower than the first standby potential Vh (V), the potential difference between the portion in the vicinity of the scan electrode SCNb and the portion in the vicinity of the sustain electrode SUSb in the discharge space can be further reduced in the discharge cell which is standing by for addressing. Thus, it is possible to further suppress the neutralization of the wall electric charge. Further, by setting the one-line address time ta in the first sub-period Ta to be shorter than the one-line address time tb in the second sub-period Th, the first sub-period Ta can be shortened, and the latter period of the first sub-period Ta and the second sub-period Th can be moved closer to the time of the termination of the reset period. Thus, it is possible to suppress the reduction in the wall electric charge and the priming particles during the address standby of the discharge cell which is subjected to the address operation in the latter period of the first sub-period Ta and in the second sub-period Th. With this, the electrically charged state in which the address discharge can be carried out at the time of termination of the reset period can be maintained more satisfactorily, and it is possible to further reduce the address error caused due to the increase in the address standby time.

Further, since the scan electrodes of the scan electrode group 4A and the scan electrodes of the scan electrode group 4B are alternately arranged in the PDP 1, the scan electrodes belonging to the scan electrode groups 4A and 4B exist uniformly on the entire panel surface (image surface) of the PDP 1. Therefore, the brightness difference generated on the image surface by, for example, the difference of the circuit impedance between the scan electrode groups 4A and 4B and the difference of load between the scan electrode groups 4A and 4B becomes unnoticeable, and the generation of the bright lines and the dark lines can be prevented. Thus, satisfactory image quality can be obtained.

In Embodiment 2, the address stop period Tr (FIG. 6) may be provided between the first sub-period Ta and the second sub-period Th, as with Modification Example of Embodiment 1.

In Embodiments 1 and 2 described above, the address operation is carried out by a single scan method. Since the address standby time of the single scan method is longer than that of a double scan method, it is possible to more effectively reduce the address error caused due to the increase in the address standby time. Note that the present invention may be applied to a configuration in which the address operation is carried out by the double scan method.

Conventionally, the address error due to the increase in the address standby time has often occurred when a partial-pressure ratio of a xenon gas in the discharge cell was high, i.e., 7% or higher. Therefore, when the partial-pressure ratio of the xenon gas in the discharge cell is 7% or higher, the address error can be reduced more effectively.

Moreover, in a case where the resolution of the plasma display panel is high, such as one million pixels (HD) or more, an area occupied by each discharge cell is small, i.e., not less than 2.696×10⁻⁴ cm² and not more than 4.432×10⁻³ cm². Therefore, the amount of wall electric charge which can be accumulated on each discharge cell is small, so that the address error caused due to the increase in the address standby time is more likely to occur. On this account, the address error can be reduced more effectively in the case of such configuration. A case where the area occupied by each discharge cell is 2.696×10⁻⁴ cm² corresponds to, for example, a case where a 37-inch screen has 1,080 scan electrodes and 4,320×3 data electrodes. A case where the area occupied by each discharge cell is 4.432×10⁻³ cm² corresponds to, for example, a case where a 100-inch screen has 1,080 scan electrodes and 1920×3 data electrodes.

In Embodiments 1 and 2, in respective sub-fields forming one field, the scan electrode group 4A on the odd-numbered rows is assigned to the first sub-period Ta that is the former period of the address period, and the scan electrode group 4B on the even-numbered rows is assigned to the second sub-period Th that is the latter period of the address period. Each of the scan electrode groups 4A and 4B may be assigned to a different sub-period, which is the former sub-period or the latter sub-period, for each field or each sub-field, or for each field and each sub-field.

In a case where each of the scan electrode groups 4A and 4B is assigned to a different sub-period for each field, in each sub-field of the first field for example, the scan electrode group 4A is assigned to the first sub-period, and the scan electrode group 4B is assigned to the second sub-period, and in each sub-field of the second field after the first field, the scan electrode group 4B is assigned to the first sub-period, and the scan electrode group 4A is assigned to the second sub-period, and in the following fields, the scan electrode groups 4A and 4B are assigned in this manner. In this case, even if the address error occurs due to the increase in the address standby time, the positions of the discharge cells which do not light due to this address error are different for each field (for example, about 16.7 ms when the frequency is 60 Hz), so that the deterioration in the image quality due to unlighting of the discharge cells cannot be recognized with eyes and becomes unnoticeable.

In a case where each of the scan electrode groups 4A and 4B is assigned to a different sub-period for each sub-field, for example, in the first sub-field in each fields, the scan electrode group 4A is assigned to the first sub-period, and the scan electrode group 4B is assigned to the second sub-period, and in the second sub-field after the first sub-field, the scan electrode group 4B is assigned to the first sub-period, and the scan electrode group 4A is assigned to the second sub-period, and in the following sub-fields, the scan electrode groups 4A and 4B are assigned in this manner. In this case, even if the address error occurs due to the increase in the address standby time, the positions of the discharge cells which do not light due to this address error are different for each sub-field (for example, about 1.5 ms when the frequency is 60 Hz, and one field includes eleven sub-fields), so that the deterioration in the image quality due to unlighting of the discharge cells cannot be recognized with eyes and becomes unnoticeable.

In a case where each of the scan electrode groups 4A and 4B is assigned to a different sub-period for each field and each sub-field, in the first sub-field in the first field for example, the scan electrode group 4A is assigned to the first sub-period, and the scan electrode group 4B is assigned to the second sub-period, and in the second sub-field after the first sub-field, the scan electrode group 4B is assigned to the first sub-period, and the scan electrode group 4A is assigned to the second sub-period, and in the following sub-fields, the scan electrode groups 4A and 4B are assigned in this manner. Then, in the first sub-field of the second field after the first field, the scan electrode group 4B is assigned to the first sub-period, and the scan electrode group 4A is assigned to the second sub-period, and in the second sub-field after the first sub-field, the scan electrode group 4A is assigned to the first sub-period, and the scan electrode group 4B is assigned to the second sub-period, and in the following sub-fields, the scan electrode groups 4A and 4B are assigned in this manner. Further, in the following fields, the scan electrode groups 4A and 4B are assigned in this manner. In this case, even if the address error occurs due to the increase in the address standby time, the positions of the discharge cells which do not light due to this address error are different for each field and each sub-field, so that the deterioration in the image quality due to unlighting of the discharge cells cannot be recognized with eyes and becomes unnoticeable.

In Embodiments 1 and 2, the scan electrodes are grouped into two scan electrode groups, and the address period includes two sub-periods (address sub-periods) to each of which the scan electrode group is assigned. However, the scan electrodes may be grouped into three or more scan electrode groups, and the address period may include three or more sub-periods to each of which the scan electrode group is assigned.

In Embodiment 1, for example, in a case where the scan electrodes are grouped into four scan electrode groups, the scan electrodes SCN1 to SCNn arranged as shown in FIG. 2 are grouped into SCNc (c=1+4j, j=0, 1, 2, . . . ), SCNd (d=2+4j), SCNe (e=3+4j), and SCNf (f=4+4j), and the scan electrodes SCNc are set as a scan electrode group C1, the scan electrodes SCNd are set as a scan electrode group D1, the scan electrodes SCNe are set as a scan electrode group E1, and the scan electrodes SCNf are set as a scan electrode group F1. In this case, the address period may be divided into four sub-periods in order of the first sub-period, the second sub-period, the third sub-period, and the fourth sub-period, and for example, the scan electrode group C1 may be assigned to the first sub-period, the scan electrode group D1 may be assigned to the second sub-period, the scan electrode group E1 may be assigned to the third sub-period, and the scan electrode group F1 may be assigned to the fourth sub-period. Then, in the first sub-period to which the scan electrode group C1 is assigned, the same potential as the scan electrode of the scan electrode group 4B on the even-numbered row in the first sub-period Ta in FIG. 5 may be applied to the scan electrodes of the scan electrode groups D1, E1, and F1. Moreover, in the second sub-period to which the scan electrode group D1 is assigned, the same potential as the scan electrode of the scan electrode group 4B on the even-numbered row in the first sub-period Ta in FIG. 5 may be applied to the scan electrodes of the scan electrode groups E1 and F1. Further, in the third sub-period to which the scan electrode group E1 is assigned, the same potential as the scan electrode of the scan electrode group 4B on the even-numbered row in the first sub-period Ta in FIG. 5 may be applied to the scan electrodes of the scan electrode group F1.

As above, in a case where the scan electrodes are grouped into three or more scan electrode groups, it is most preferable that the same potential as the scan electrode group 4B on the even-numbered row in the first sub-period Ta in FIG. 5 be applied to an arbitrary scan electrode group in all the sub-periods before the sub-period to which the arbitrary scan electrode group is assigned. However, the same potential as the scan electrode group 4B on the even-numbered row in the first sub-period Ta in FIG. 5 is applied to at least one scan electrode group in at least one sub-period before the sub-period to which the above one scan electrode group is assigned. With this, the address error can be reduced to some extent.

In Embodiment 2, for example, in a case where the scan electrodes are grouped into four scan electrode groups, the scan electrodes SCN1 to SCNn arranged as shown in FIG. 2 are grouped into SCNc (c=1+4j, j=0, 1, 2, . . . ), SCNd (d=2+4j), SCNe (e=3+4j), and SCNf (f=4+4j), and the scan electrodes SCNc are set as the scan electrode group C1, the scan electrodes SCNd are set as the scan electrode group D1, the scan electrodes SCNe are set as the scan electrode group E1, and the scan electrodes SCNf are set as the scan electrode group F1. Moreover, the sustain electrodes which form pairs with the scan electrodes are grouped in the same manner as above. To be specific, the sustain electrodes SUS1 to SUSn are grouped into SUSc (c=1+4j, j=0, 1, 2, . . . ), SUSd (d=2+4j), SUSe (e=3+4j), and SUSf (f=4+4j), and the sustain electrodes SUSc are set as a sustain electrode group C2, the sustain electrodes SUSd are set as a sustain electrode group D2, the sustain electrodes SUSe are set as a sustain electrode group E2, and the sustain electrodes SUSf are set as a sustain electrode group F2. In this case, the address period may be divided into four sub-periods in order of the first sub-period, the second sub-period, the third sub-period, and the fourth sub-period, and for example, the scan electrode group C1 may be assigned to the first sub-period, the scan electrode group D1 may be assigned to the second sub-period, the scan electrode group E1 may be assigned to the third sub-period, and the scan electrode group F1 may be assigned to the fourth sub-period. Then, in the first sub-period to which the scan electrode group C1 is assigned, the same potential as the scan electrode of the scan electrode group 4B on the even-numbered row in the first sub-period Ta in FIG. 8 may be applied to the scan electrodes of the scan electrode groups D1, E1, and F1, and the same potential as the sustain electrode of the sustain electrode group 5B on the even-numbered row in the first sub-period Ta in FIG. 8 may be applied to the sustain electrodes of the sustain electrode groups D2, E2, and F2. Moreover, in the second sub-period to which the scan electrode group D1 is assigned, the same potential as the scan electrode of the scan electrode group 4B on the even-numbered row in the first sub-period Ta in FIG. 8 may be applied to the scan electrodes of the scan electrode groups E1 and F1, and the same potential as the sustain electrode of the sustain electrode group 5B on the even-numbered row in the first sub-period Ta in FIG. 8 may be applied to the sustain electrodes of the sustain electrode groups E2 and F2. Further, in the third sub-period to which the scan electrode group E is assigned, the same potential as the scan electrode of the scan electrode group 4B on the even-numbered row in the first sub-period Ta in FIG. 8 may be applied to the scan electrodes of the scan electrode group F1, and the same potential as the sustain electrode of the sustain electrode group 5B on the even-numbered row in the first sub-period Ta in FIG. 8 may be applied to the sustain electrodes of the sustain electrode group F2.

As above, in a case where the scan electrodes are grouped into three or more scan electrode groups, it is most preferable that the same potential as the scan electrode group 4B and the sustain electrode group 5B on the even-numbered row in the first sub-period Ta in FIG. 8 be applied to an arbitrary scan electrode group and its corresponding sustain electrode group in all the sub-periods before the sub-period to which the arbitrary scan electrode group is assigned. However, the same potential as the scan electrode group 4B on the even-numbered row in the first sub-period Ta in FIG. 8 is applied to at least one scan electrode group, and the same potential as the sustain electrode group 5B on the even-numbered row in the first sub-period Ta in FIG. 8 is applied to the sustain electrode group corresponding to the above one scan electrode group, in at least one sub-period before the sub-period to which the above one scan electrode group is assigned. With this, the address error can be reduced to some extent.

The one-line address time of the scan electrode in a case where the scan electrodes are grouped into three or more scan electrode groups as above may be set as below. The following will explain a case where, for example, the scan electrodes are grouped into four scan electrode groups C1 to F1 as above, and the address period is divided into four sub-periods in order of the first to fourth sub-periods. In this case, the one-line address time of the scan electrode group C1 in the first sub-period is referred to as tc, the one-line address time of the scan electrode group D1 in the second sub-period is referred to as td, the one-line address time of the scan electrode group E1 in the third sub-period is referred to as te, and the one-line address time of the scan electrode group F1 in the fourth sub-period is referred to as tf. By setting these times tc, td, te, and tf to tc<td<te<tf, the first to third sub-periods can be shortened. Thus, it is possible to suppress the reduction in the wall electric charge and the priming particles in the address standby of the discharge cell which is subjected to the address operation in the second to fourth sub-periods. As above, it is most preferable that the one-line address times be set such that the closer the sub-period is to the reset period, the shorter the one-line address time is. However, a certain level of effect can be obtained even in a case where the times tc, td, te, and tf are set to tc<td<te=tf, tc<td=te<tf, tc=td<te<tf, tc<td=te=tf, tc=td=te<tf, or the like. Even in a case of td<te=tf=tc or te<td=tf=tc, at least the last sub-period can be moved closer to the time of the termination of the reset period, so that a certain level of effect can be obtained. To be specific, at least one of a plurality of sub-periods forming the address period may be a sub-period to which the one-line address time shorter than that of the last sub-period is set. Note that none of a plurality of sub-periods forming the address period is a sub-period to which the one-line address time longer than that of the last sub-period is set.

Even in a case where the scan electrodes are grouped into three or more scan electrode groups, the address stop period may be provided between the sub-periods as described in Modification Example of Embodiment 1.

Moreover, even in a case where the scan electrodes are grouped into three or more scan electrode groups, the scan electrode group may be assigned to a different sub-period for each field or each sub-field, or for each field and each sub-field.

Note that the increase in the number of the scan electrode groups causes complication of the scan electrode driving circuit 13 and complication of control. Further, in Embodiment 2, in the case of increasing the number of the scan electrode groups, the number of the sustain electrode groups also increases. Therefore, this causes the complication of the sustain electrode driving circuit 14 and the complication of control. In consideration of these demerits, it is preferable that the number of the scan electrode groups be two.

In the foregoing, the numbers of the scan electrodes belonging to respective scan electrode groups are equal to one another, however may be different from one another. Moreover, the scan electrodes belonging to respective scan electrode groups are arranged one by one in order, however, the present embodiment is not limited to this. Each scan electrode group may include a plurality of scan electrode sub-groups each including at least one scan electrode (or a plurality of adjacent scan electrodes), and the scan electrodes may be grouped such that the scan electrode sub-groups of different scan electrode groups are adjacent to each other, and the scan electrode sub-groups of the same scan electrode group are not adjacent to each other. Here, an example in which each scan electrode sub-group includes one scan electrode is shown in FIGS. 4 and 7. For example, each scan electrode sub-group may include two adjacent scan electrodes. Moreover, the number of the scan electrodes included in the scan electrode sub-group may be different for each scan electrode group, and the number of the scan electrodes included in the scan electrode sub-group may be different for each scan electrode sub-group.

From the foregoing explanation, many modifications and other embodiments of the present invention are obvious to one skilled in the art. Therefore, the foregoing explanation should be interpreted only as an example, and is provided for the purpose of teaching the best mode for carrying out the present invention to one skilled in the art. The structures and/or functional details may be substantially modified within the spirit of the present invention.

### INDUSTRIAL APPLICABILITY

A method for driving a plasma display panel and a plasma display apparatus according to the present invention is useful as, for example, an image display apparatus capable of further reducing an address error and obtaining satisfactory image quality.

1. A method for driving a plasma display panel in which plural pairs of display electrodes, each pair being formed by a scan electrode and a sustain electrode forming a pair, and a plurality of data electrodes are arranged to intersect with each other with a gap therebetween, and which includes a plurality of discharge cells each of which includes the pair of display electrodes and the data electrode forming the gap and has a discharge space in the gap,
the method comprising the steps of:
grouping a plurality of the scan electrodes included in the plural pairs of display electrodes into a plurality of scan electrode groups such that: said plurality of scan electrodes are grouped into said plurality of scan electrode groups; each of the scan electrode groups includes a plurality of scan electrode sub-groups each including at least one scan electrode; the scan electrode sub-groups included in the different scan electrode groups are adjacent to each other; and the scan electrode sub-groups included in the same scan electrode group are not adjacent to each other;
dividing each field period into a plurality of sub-fields each including a reset period in which an inside of the discharge cell is caused to be an electrically charged state in which address discharge is able to be carried out, an address period in which the address discharge is caused in the discharge cell which is caused to light, and a sustain period in which the discharge cell in which the address discharge is caused is caused to light;
dividing the address period in each of the sub-fields into a plurality of address sub-periods to which the different scan electrode groups are assigned, respectively;
sequentially selecting the scan electrode by applying a selective potential or a first non-selective potential based on selection or non-selection to the scan electrode of the scan electrode group assigned to the address sub-period, and applying an address potential to the data electrode to be selected in sync with the selection of the scan electrode so that the address discharge is caused in the address sub-period in the discharge cell to be lit among the discharge cells including the scan electrodes of the scan electrode group assigned to the address sub-period;
setting a time during which the selective potential is applied to the scan electrode in one of said plurality of address sub-periods other than a last one of the address sub-periods to be shorter than a time during which the selective potential is applied to the scan electrode in the last one of the address sub-periods; and
applying a second non-selective potential higher than the first non-selective potential to the scan electrodes of one of the scan electrode groups in any one of the address sub-periods before the address sub-period to which said one of the scan electrode groups is assigned.

2. The method for driving the plasma display panel according to claim 1, further comprising the steps of:
applying a first standby potential to the sustain electrodes which form pairs with the scan electrodes of the scan electrode group assigned to the address sub-period; and
applying a second standby potential lower than the first standby potential to the sustain electrodes which form pairs with the scan electrodes of said one scan electrode group in any one of the address sub-periods before the address sub-period to which said one scan electrode group is assigned.

3. The method for driving the plasma display panel according to claim 2, wherein the second standby potential is higher than the selective potential.

4. The method for driving the plasma display panel according to claim 2, wherein the second standby potential is a ground potential.

5. The method for driving the plasma display panel according to claim 1, further comprising the steps of:
applying the second non-selective potential to the scan electrodes of said one scan electrode group in the address sub-period immediately before the address sub-period to which said one scan electrode group is assigned;
providing between the address sub-period immediately before the address sub-period to which said one scan electrode group is assigned and the address sub-period to which said one scan electrode group is assigned, an address stop period which has a predetermined time and in which the selective potential is not applied to any scan electrodes; and
switching the potential applied to the scan electrodes of said one scan electrode group from the second non-selective potential to the first non-selective potential in a former half period of the address stop period.

6. The method for driving the plasma display panel according to claim 5, wherein the predetermined time of the address stop period is preset such that a change in the potential of the sustain electrode caused by switching the potential applied to the scan electrodes of said one scan electrode group to the first non-selective potential in the former half period of the address stop period substantially terminates within the address stop period.

7. The method for driving the plasma display panel according to claim 1, wherein:
any one of a first lamp potential which drops after rising and a second lamp potential which drops from a potential lower than a highest potential of the first lamp potential is applied to the scan electrode in the reset period of each sub-field period; and
the second non-selective potential is lower than the highest potential of the first lamp potential.

8. The method for driving the plasma display panel according to claim 1, wherein a number of the scan electrode groups is two.

9. The method for driving the plasma display panel according to claim 1, wherein the scan electrode group assigned to each of the address sub-periods is different for each field.

10. The method for driving the plasma display panel according to claim 1, wherein the scan electrode group assigned to each of the address sub-periods is different for each sub-field.

11. The method for driving the plasma display panel according to claim 1, wherein the scan electrode group assigned to each of the address sub-periods is different for each field and each sub-field.

12. The method for driving the plasma display panel according to claim 1, wherein the discharge cell is filled with a discharge gas containing a xenon gas at a partial-pressure ratio of 7% or higher.

13. The method for driving the plasma display panel according to claim 1, wherein:
each of the data electrodes is arranged to intersect with all the scan electrodes; and
the scan electrodes are selected one by one in the address period.

14. The method for driving the plasma display panel according to claim 1, wherein an area occupied by each of the discharge cells is not less than 2.696×10⁻⁴ cm² and not more than 4.432×10⁻³ cm².

15. A plasma display apparatus comprising:
a plasma display panel in which plural pairs of display electrodes, each pair being formed by a scan electrode and a sustain electrode forming a pair, and a plurality of data electrodes are arranged to intersect with each other with a gap therebetween, and which includes a plurality of discharge cells each of which includes the pair of display electrodes and the data electrode forming the gap and has a discharge space in the gap; and
a driving device which drives the plasma display panel, wherein
the driving device is configured to:
group a plurality of the scan electrodes included in the plural pairs of display electrodes into a plurality of scan electrode groups such that said plurality of scan electrodes are grouped into said plurality of scan electrode groups, each of the scan electrode groups includes a plurality of scan electrode sub-groups each including at least one scan electrode, the scan electrode sub-groups included in the different scan electrode groups are adjacent to each other, and the scan electrode sub-groups included in the same scan electrode group are not adjacent to each other;
divide each field period into a plurality of sub-fields each including a reset period in which an inside of the discharge cell is caused to be an electrically charged state in which address discharge is able to be carried out, an address period in which the address discharge is caused in the discharge cell which is caused to light, and a sustain period in which the discharge cell in which the address discharge is caused is caused to light;
divide the address period in each of the sub-fields into a plurality of address sub-periods to which the different scan electrode groups are assigned, respectively;
sequentially select the scan electrode by applying a selective potential or a first non-selective potential based on selection or non-selection to the scan electrode of the scan electrode group assigned to the address sub-period, and applying an address potential to the data electrode to be selected in sync with the selection of the scan electrode so that the address discharge is caused in the address sub-period in the discharge cell to be lit among the discharge cells including the scan electrodes of the scan electrode group assigned to the address sub-period;
set a time during which the selective potential is applied to the scan electrode in one of said plurality of address sub-periods other than a last one of the address sub-periods to be shorter than a time during which the selective potential is applied to the scan electrode in the last one of the address sub-periods; and
apply a second non-selective potential higher than the first non-selective potential to the scan electrodes of one of the scan electrode groups in any one of the address sub-periods before the address sub-period to which said one of the scan electrode groups is assigned.

16. The plasma display apparatus according to claim 15, wherein the driving device applies a first standby potential to the sustain electrodes which form pairs with the scan electrodes of the scan electrode group assigned to the address sub-period, and applies a second standby potential lower than the first standby potential to the sustain electrodes which form pairs with the scan electrodes of said one scan electrode group in any one of the address sub-periods before the address sub-period to which said one scan electrode group is assigned.

17. The plasma display apparatus according to claim 16, wherein the second standby potential is higher than the selective potential.

18. The plasma display apparatus according to claim 16, wherein the second standby potential is a ground potential.

19. The plasma display apparatus claim 15, wherein the driving device
applies the second non-selective potential to the scan electrodes of said one scan electrode group in the address sub-period immediately before the address sub-period to which said one scan electrode group is assigned,
provides between the address sub-period immediately before the address sub-period to which said one scan electrode group is assigned and the address sub-period to which said one scan electrode group is assigned, an address stop period which has a predetermined time and in which the selective potential is not applied to any scan electrodes, and
switches the potential applied to the scan electrodes of said one scan electrode group from the second non-selective potential to the first non-selective potential in a former half period of the address stop period.

20. The plasma display apparatus according to claim 15, wherein the driving device presets the predetermined time of the address stop period such that a change in the potential of the sustain electrode caused by switching the potential applied to the scan electrodes of said one scan electrode group to the first non-selective potential in the former half period of the address stop period substantially terminates within the address stop period.

21. The plasma display apparatus according to claim 15, wherein:
the driving device applies to the scan electrode in the reset period of each sub-field period, any one of a first lamp potential which drops after rising and a second lamp potential which drops from a potential lower than a highest potential of the first lamp potential; and
the second non-selective potential is lower than the highest potential of the first lamp potential.

22. The plasma display apparatus according to claim 15, wherein a number of the scan electrode groups is two.

23. The plasma display apparatus according to claim 15, wherein the scan electrode group assigned to each of the address sub-periods is different for each field.

24. The plasma display apparatus according to claim 15, wherein the scan electrode group assigned to each of the address sub-periods is different for each sub-field.

25. The plasma display apparatus according to claim 15, wherein the scan electrode group assigned to each of the address sub-periods is different for each field and each sub-field.

26. The plasma display apparatus according to claim 15, wherein the discharge cell is filled with a discharge gas containing a xenon gas at a partial-pressure ratio of 7% or higher.

27. The plasma display apparatus according to claim 15, wherein:
each of the data electrodes is arranged to intersect with all the scan electrodes; and the driving device selects the scan electrodes one by one in the address period.

28. The plasma display apparatus according to claim 15, wherein an area occupied by each of the discharge cells is not less than 2.696×10⁻⁴ cm² and not more than 4.432×10⁻³ cm².
